(19) United States
(12) Patent Application Publication
(10) Pub. No.: US 2012/0154698 A1
(43) Pub. Date: Jun. 21, 2012

(54) STEREOSCOPIC IMAGE DISPLAY APPARATUS

(75) Inventors: Kenji Matsuhiro, Tokyo (JP); Yoshihiro Yoshihara, Niigata (JP); Hiroshi Maruyama, Niigata (JP)

(73) Assignee: ARISAWA MFG. CO., LTD., Niigata (JP)

(21) Appl. No.: 13/388,330

(22) PCT Filed: May 25, 2011
(86) PCT No.: PCT/JP2011/062008

§ 371 Date: Mar. 5, 2012

(30) Foreign Application Priority Data
Aug. 17, 2010 (JP) 2010-182532

(51) Int. Cl. G02F 1/1335

(52) U.S. Cl. 349/15

(57) ABSTRACT

A stereoscopic image display apparatus reduces flicker and crosstalk, and provides a viewing screen of high brightness without decreasing resolution. The stereoscopic image display apparatus includes: a liquid crystal display which has a first image forming area and a second image forming area corresponding to horizontal rows; and an optical unit in which a first polarizing area and a second polarizing area are arranged in correspondence with the first and second image forming areas. A frame image displays a right eye image on the first image forming area and a left eye image on the second image forming area, and alternately replaces or overwrites the image forming areas every time the frame is switched. The optical unit replaces, in synchronization with the timing at which the first and second image forming areas are replaced. The phase difference states are replaced between the first polarizing area and the second polarizing area.

### TECHNICAL FIELD

The present invention relates to a stereoscopic image display apparatus.

### BACKGROUND ART

Recently, liquid crystal televisions using liquid crystal displays have been actively developed. Further, as an approach for achieving a higher function, development of a stereoscopic image display apparatus using a liquid crystal display is being advanced.

A plurality of types of schemes is proposed for this stereoscopic image display apparatus using the liquid crystal display apparatus. For example, a parallax barrier scheme, a lenticular lens scheme and a switch backlight scheme are known. Although these schemes provide an advantage that a viewer does not need dedicated glasses to view video images from a display apparatus, the parallax barrier scheme and the lenticular lens scheme have a problem that, the horizontal resolution is decreased and therefore the resolution of image display generally decreases. The switch backlight scheme has a problem in that flickering of images occurs.

Further, as a scheme using dedicated glasses, a shutter glass scheme is known. This scheme provides an advantage of widening a display view angle of an image display apparatus without decreased resolution. However, this scheme has problems, such as, flickering of the display images, the brightness of a display screen is decreased, and there is a time lag between images visible to left and right eyes, therefore, natural images cannot be provided for a viewer.

Further, a stereoscopic image display apparatus is recently proposed which uses novel optical units to provide stereoscopic images. For example, Patent Literature 1 discloses a stereoscopic image display apparatus which does not require dedicated glasses by using two polarization filters which are such novel optical units.

With the stereoscopic image display apparatus disclosed in Patent Literature 1, a right eye polarization filter and a left eye polarization filter, having the polarization directions orthogonal to each other, are arranged in the front left and right of a light source. Further, respective lights transmitted through these filters are converted into substantially parallel lights by a Fresnel lens and radiate a liquid crystal display. Furthermore, linear polarization filter lines which are orthogonal to each other are alternately arranged per horizontal line of polarization filters on both surfaces of this liquid crystal display, and opposing linear polarization filter lines on the light source side and viewer side polarization directions which are orthogonal. Still further, the liquid crystal panel of the liquid crystal display is configured to alternately display right eye video information and left eye video information per horizontal line according to transmittance lines of two polarization filters.

That is, all horizontal scan lines of a display screen are divided into odd lines and even lines and left eye and right eye images are displayed on respective lines to sort and display these left eye and right eye images for the left and right eyes of the viewer by means of novel optical units to display stereoscopic images.

This apparatus does not cause stereoscopic images to deteriorate even if a viewing position of a viewer is moved more or less to the left or right, and can avoid a phenomenon in which a horizontal resolution is decreased by half which is the problem of the parallax scheme and the lenticular lens scheme.

Further, Patent Literature 2 discloses a stereoscopic image display apparatus which uses novel retarders as novel optical units which have two different areas which make polarizing axes of incident lights orthogonal to each other. This stereoscopic image display apparatus has a liquid crystal display which displays a right eye image and a left eye image on different areas, and the retarders corresponding to left and right image display areas, and provides stereoscopic images by projecting parallax images toward the viewer. Further, this stereoscopic image display apparatus is known to display images of a wider view angle.

### CITATION LIST

### Patent Literature

PTL 1 Japanese Patent Application Laid-Open No. Hei 10-63199
PTL 2 Japanese Patent Application Laid-Open No. 2006-284873

### SUMMARY OF INVENTION

### Technical Problem

However, the stereoscopic image display apparatus using polarization filters disclosed in Patent Literature 1 always has a fixed display position for a right eye video signal and a fixed display position for a left eye video signal on the display screen, and therefore has a new problem that vertical resolutions of left and right video images decrease by half

Further, the stereoscopic image display apparatus using the novel retarders disclosed in Patent Literature 2 also always has a fixed display position for a right eye video signal and a fixed display position for a left eye video signal on the display screen, and therefore has a new problem that vertical resolutions of left and right video images decrease by half

Hence, the conventional stereoscopic image display apparatus is not sufficient to reduce flickers, maintain a high brightness in the screen and prevent a decrease in the resolution, and therefore a new stereoscopic image display apparatus is demanded.

The present invention has been made in light of the foregoing. That is, it is therefore an object of the present invention to provide a stereoscopic image display apparatus which reduces flickers, provides a high brightness in the screen and enables simultaneous viewing of left and right video images without decreasing the resolution in the screen.

Other challenges and advantages of the present invention are apparent from the following description.

### Solution to Problem

A stereoscopic image display apparatus according to the present invention comprising:

A liquid crystal display which comprises:

a liquid crystal panel formed by aligning in a vertical direction a plurality of horizontal lines formed by aligning pixels in a horizontal direction, and a pair of polarizing plates which sandwich the liquid crystal panel;

a backlight which is arranged on a back surface side of the liquid crystal display;

an optical unit which is provided on a front surface side of the liquid crystal display;

polarized glasses which a viewer wears to use; and

a controlling apparatus which controls image display in the liquid crystal display, and phase difference states of the optical unit, wherein

the liquid crystal display comprises a first image forming area and a second image forming area, and is controlled by the controlling apparatus such that the first image forming area displays one of a right eye image and a left eye image and, simultaneously, the second image forming area displays the other image and is configured to display a frame image in which the right eye image and the left eye image are interlaced respectively,

the first image forming area and the second image forming area are configured to

(1) replace a right eye image and a left eye image every time a frame is switched, or

(2) in cases other than (1), replace the right eye image and the left eye image when a frame is switched or overwrite an image displayed in a frame immediately before, and

the optical unit is configured such that a first polarizing area and a second polarizing area are arranged in ranges corresponding to the first image forming area and the second image forming area and respectively have different phase difference states, the different phase difference states being controlled by the controlling apparatus in synchronization with a timing at which the right eye image and the left eye image are replaced.

The optical unit preferably is configured such that the first polarizing area and the second polarizing area are controlled by the controlling apparatus to respectively have different phase difference states, and phase difference states are replaced between the first polarizing area and the second polarizing area in synchronization with a timing at which the right eye image and the left eye image are replaced in the liquid crystal display.

The first image forming area and the second image forming area preferably correspond to each horizontal line for displaying a stereoscopic image on the liquid crystal display, and the first image forming area corresponds to odd horizontal lines and the second image forming area corresponds to even horizontal lines,

the odd horizontal lines display one of a right eye image and a left eye image, and the even horizontal lines display the other image,

the horizontal lines are configured to

(1) replace a right eye image and a left eye image every time a frame is switched, or

(2) in cases other than (1), replace the right eye image and left eye image when a frame is switched or overwrite an image displayed in a frame immediately before, and

the optical unit is configured such that a first polarizing area and a second polarizing area are arranged in ranges corresponding to the odd horizontal line and the even horizontal line and respectively have different phase difference states, the different phase difference states being controlled by the controlling apparatus to replace between the first polarizing area and the second polarizing area in synchronization with a timing at which the right eye image and the left eye image are replaced.

The backlight is preferably configured such that the controlling apparatus controls an entire lighting state according to a timing at which the right eye image and the left eye image are replaced, or is configured such that part of a lighting state is controlled following replacement of phase difference states between the first polarizing area and the second polarizing area to perform scanning.

The controlling apparatus preferably controls each horizontal line of the liquid crystal display to control replacement between the right eye image and the left eye image in the liquid crystal display, and controls a phase difference state of the first polarizing area or the second polarizing area of the optical unit corresponding to the controlled horizontal lines of the liquid crystal display.

The controlling apparatus more preferably sequentially controls each horizontal line from an upper horizontal line to a lower horizontal line of the liquid crystal display to control replacement between a right eye image and a left eye image, and sequentially controls the optical unit from top to bottom by synchronizing replacement of phase difference states between the first polarizing area and the second polarizing area in the optical unit, with the control of the liquid crystal display.

The optical unit is preferably formed by sandwiching liquid crystal between a pair of substrates comprising transparent electrodes disposed on opposing surfaces and providing a phase difference film on outer surfaces of the substrates which sandwich the liquid crystal.

A light blocking unit is preferably provided in at least part of a boundary between the first polarizing area and the second polarizing area of the optical unit.

The optical unit is preferably formed using one of liquid crystal elements selected from the group consisting of a TN liquid crystal element, a homogeneous liquid crystal element and a ferroelectric liquid crystal element.

The substrates forming the optical unit are preferably formed using one film selected from the group consisting of a polycarbonate film, a triacetylcellulose film, a cycloolefin polymer film, a polyethersulfone film and a glass cloth reinforced transparent film.

The liquid crystal display preferably switches frames at a cycle of 120 Hz or more.

The liquid crystal display more preferably switches frames at a cycle of at least 240 Hz.

### Advantageous Effects of Invention

According to the first aspect of the present invention, a right eye image and a left eye image are simultaneously displayed on one screen and, even when areas to form a right eye image and a left eye image are replaced following switching of a frame, the viewer can view only right eye image light with the right eye and view only left eye image light with the left eye. Consequently, the viewer can recognize the right eye image light and left eye image light as stereoscopic images at all times.

Further, with a conventional stereoscopic image display apparatus, vertical resolution is decreased by half and resolution thereby is decreased, whereas in the present embodiment the stereoscopic image display apparatus can display stereoscopic images at the full resolution without any decrease resolution. Further, right eye and left eye images are displayed at all times, so that it is possible to alleviate fatigue of the viewer. Furthermore, it is also possible to provide an effect of canceling a sense of difference in a stereoscopic view resulting from misalignment between left and right images which occurs in case of fast moving stereoscopic images.

Furthermore, it is possible to reduce crosstalk, which is a phenomenon in that part of a right eye image unintentionally reaches the viewer's left eye.

Moreover, it is possible to display stereoscopic images of a high brightness.

### BRIEF EXPLANATION OF DRAWINGS

FIG. 1 is a schematic exploded perspective view describing a configuration of the main parts of a stereoscopic image display apparatus according to the present embodiment.

FIG. 2 is a schematic sectional view of the liquid crystal display portion and switching retarder portion of the stereoscopic image display apparatus according to the present embodiment.

FIG. 3 is a schematic exploded perspective view describing configurations of the right eye glass and the left eye glass.

FIG. 4(a) is a view schematically illustrating an electrode structure of a conventional passive driving liquid crystal display element, and FIG. 4(b) is a view schematically illustrating an electrode structure of the switching retarder according to the present embodiment.

FIG. 5(a) is a view schematically illustrating a configuration of a conventional active driving liquid crystal display element, and FIG. 5(b) is a view schematically illustrating a configuration of main parts of the switching retarder according to the present embodiment using the active driving liquid crystal element.

FIG. 6(a) is a view describing a method of making the viewer recognize one frame image, and FIG. 6(b) is a view describing a method of making the viewer recognize a frame image after image display areas are replaced following switching of a frame.

FIG. 7(a) and FIG. 7(b) are diagrams illustrating the configuration and function of the switching retarder according to the first example of the switching retarder in the present embodiment.

FIG. 8(a) and FIG. 8(b) are diagrams illustrating the configuration and function of the switching retarder according to the second example of the switching retarder in the present embodiment.

FIG. 9(a) and FIG. 9(b) are diagrams illustrating the configuration and function of the switching retarder according to the third example of the switching retarder in the present embodiment.

FIG. 10 is a view describing a display method of a common liquid crystal display.

FIG. 11 explains the first operational method of the stereoscopic image display apparatus.

FIGS. 12(a) through 12(f) are diagrams illustrating a second operational method of stereoscopic image display apparatus.

### DESCRIPTION OF EMBODIMENT

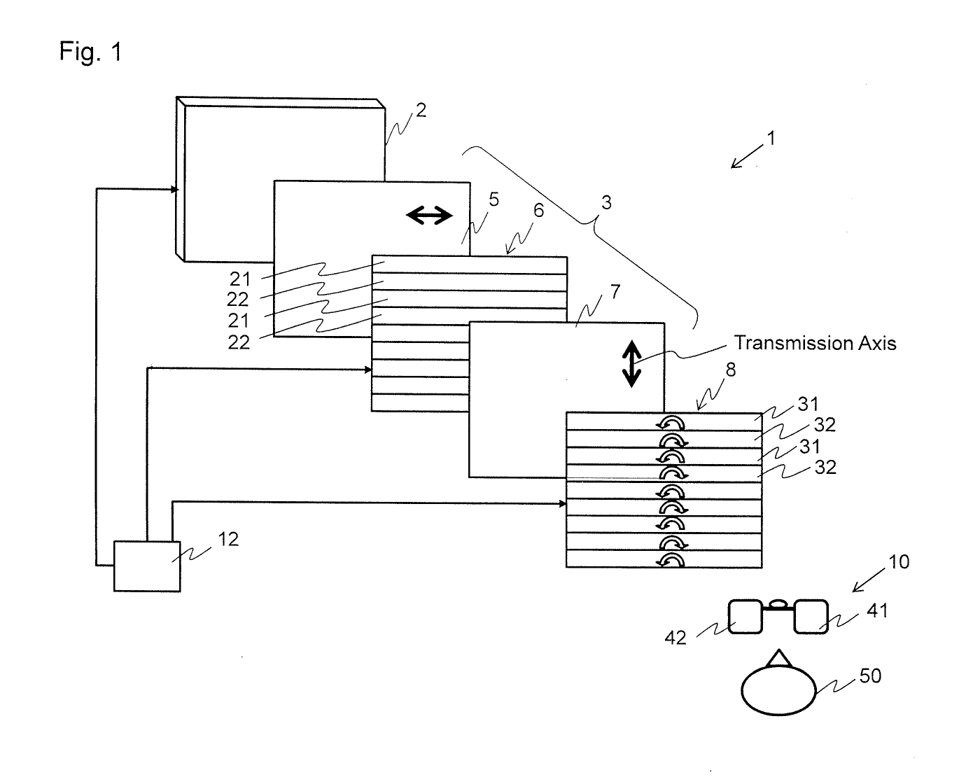

FIG. 1 is a schematic exploded perspective view describing a configuration of the main parts of a stereoscopic image display apparatus 1 according to the present embodiment. As illustrated in FIG. 1, the stereoscopic image display apparatus 1 has a backlight 2, a liquid crystal display 3, and a switching retarder 8 of an optical unit, in this order, and has a controlling apparatus 12 which controls the backlight 2, the liquid crystal display 3 and the switching retarder 8. Further, these are accommodated in a housing (not illustrated). Further, the stereoscopic image display apparatus 1 includes polarized glasses 10, and a viewer 50 who views stereoscopic images wears these polarized glasses 10, and views images on the screen from the front side of the retarder 8.

The backlight 2 is arranged in the farthest side of the stereoscopic image display apparatus 1 seen from the viewer, and emits non-polarized white light with a uniform light amount to one surface of a polarizing plate 5 in a state where the stereoscopic image display apparatus 1 displays images (hereinafter, “the state of use of the stereoscopic image display apparatus 1”). In addition, although a planar light source is used for the backlight 2 in the present embodiment, a combination of a point light source such as LED and a condensing lens may be used instead of the planar light source. An example of this condensing lens is a Fresnel lens sheet. The Fresnel lens sheet has on one side a lens surface which coaxially has a convexity and concavity, and can convert light incident from the focus in the center of the back side into substantially parallel light and emit light toward the front surface.

As illustrated in FIG. 1, the liquid crystal display 3 is formed with a liquid crystal panel 6 sandwiched by a pair of the polarizing plate 5 and polarizing plate 7.

The polarizing plate 5 is disposed on the backlight 2 side in the liquid crystal panel 6 in the liquid crystal display 3. The polarizing plate 5 has a transmission axis and an absorption axis orthogonal to the transmission axis and, when non-polarized light emitted from the backlight 2 is incident on the polarizing plate, allows transmission of non-polarized light having the polarizing axis parallel to a transmission axis direction and blocks light having the polarizing axis parallel to the absorption axis direction. The direction of the polarizing axis refers to a vibration direction of the electric field of light, and the direction of the transmission axis in the polarizing plate 5 refers to a direction parallel to the horizontal direction in which the viewer 50 looks at the stereoscopic image display apparatus 1 as indicated by the arrow in FIG. 1.

The liquid crystal panel 6 is formed by sandwiching a liquid crystal by means of, glass substrates on which transparent electrodes made of ITO (Indium Tin Oxide) are disposed. Further, it is possible to use liquid crystal panels of a TN (Twisted Nematic) mode, IPS (In-Plane-Switching) mode or VA (Vertical Alignment) mode. With these liquid crystal panels, the orientation of a liquid crystal changes according to the voltage applied thereby enabling adjustment of the transmission light amount in combination with the functions of the polarizing plates 5 and 7 disposed on both surfaces of the liquid crystal panel 6.

Further, the liquid crystal panel 6 is a component which forms images in the stereoscopic image display apparatus 1, and simultaneously displays a right eye image and a left eye image on one screen. Hereinafter, this configuration and function related to image display will be described.

First, the image display portion of the liquid crystal panel 6 is divided in the horizontal direction to provide first image forming areas 21 and second image forming areas 22. As shown in FIG. 1, the first image forming areas 21 and second image forming areas 22 both have the substantially same area obtained by dividing the liquid crystal panel 6 in a horizontal direction, and a plurality of first image forming areas 21 and second image forming areas 22 are alternately arranged in the vertical direction.

Further, the liquid crystal panel 6 of the liquid crystal display 3 of the stereoscopic image display apparatus 1 displays a right eye image and a left eye image of one frame image to be displayed, on the first image forming areas 21 and the second image forming areas 22, respectively, and replace the right eye image and the left eye image between the first image forming areas 21 and the second image forming areas 22 according to the following method of (1) or (2).
(1) The right eye image and the left eye image are replaced every time the frame is switched.
(2) In cases other than (1), the right eye image and the left eye image are replaced when the frame is switched, or an image displayed in a previous frame is overwritten (note that (2) does not include a case where the right eye image and the left eye image are maintained respectively without being replaced).

As a result, it is possible to display a frame image in which the right eye image and the left eye image are interlaced, respectively.

Further, the stereoscopic image display apparatus 1 according to the present embodiment in particular can be formed by alternately providing the first image forming areas 21 and the second image forming areas 22 to correspond to all respective horizontal lines of the liquid crystal panel 6 which are used to display images.

In this case a right eye image and a left eye image are displayed on the first image forming areas 21 corresponding to odd horizontal lines of one frame image to be displayed and the second image forming areas 22 corresponding to the even horizontal lines, respectively, and according to the above method of (1) and (2), the right eye image and the left eye image can be replaced between the first image forming areas 21 and the second image forming areas 22. Further, it is possible to display a frame image in which the right eye image and the left eye image are respectively interlaced.

In addition, although not shown in FIG. 1, an outer frame is arranged in the peripheral rim of the liquid crystal panel 6, and the first image forming areas 21 and the second image forming areas 22 in the liquid crystal panel 6 are supported by this outer frame.

As described above, in the state where the stereoscopic image display apparatus 1 is used, when one frame image is displayed, a right eye image and a left eye image are generated on the first image forming areas 21 and the second image forming areas 22 of the liquid crystal panel 6. When light transmitted through the polarizing plate 5 is incident on the first image forming areas 21 and the second image forming areas 22 of the liquid crystal panel 6, transmission light of the first image forming areas 21 becomes image light for the right eye image (hereinafter abbreviated as “right eye image light”) and transmission light of the second image forming areas 22 becomes image light for the left eye image (hereinafter abbreviated as “left eye image light”). Further, in the case where the right eye image and the left eye image are replaced following switching of a frame, a left eye image and a right eye image are formed respectively on the first image forming areas 21 and the second image forming areas 22.

In addition, when one frame image is displayed as described above, right eye image light transmitted through the first image forming areas 21 and left eye image light transmitted through the second image forming areas 22 transmit through the polarizing plate 7 (described later), and become linear polarized lights having polarizing axes in respective specific directions. Meanwhile, the respective polarizing axes in respective directions may be mutually the same direction, and are the same direction as the direction of the transmission axis of the polarizing plate 7 (described later) as seen in FIG. 1.

The polarizing plate 7 is arranged on the viewer side in the liquid crystal display 3. When right eye image light transmitted through the first image forming areas 21 and left eye image light transmitted through the second image forming areas 22 in the above case are incident on the polarizing plate 7, the polarizing plate 7 allows transmission of light of these lights having the polarizing axis parallel to the transmission axis and blocks light having the polarizing axis parallel to the absorption axis (vertical to the transmission axis). As indicated by the arrow in FIG. 1, the direction of the transmission axis in the polarizing plate 7 is a direction vertical to the horizontal direction when the viewer looks at the stereoscopic image display apparatus 1.

The switching retarder 8 according to the present embodiment is the principal constituent component of the stereoscopic image display apparatus 1, consisting of first polarizing areas 31 and second polarizing areas 32. As illustrated in FIG. 1, the positions and sizes of the first polarizing areas 31 and the second polarizing areas 32 in this switching retarder 8 correspond to the ranges, that is, the positions and sizes of the first image forming areas 21 and the second image forming areas 22 in the liquid crystal panel 6. Furthermore, the switching retarder 8 can switch phase difference states of the first polarizing areas 31 and the second polarizing areas 32.

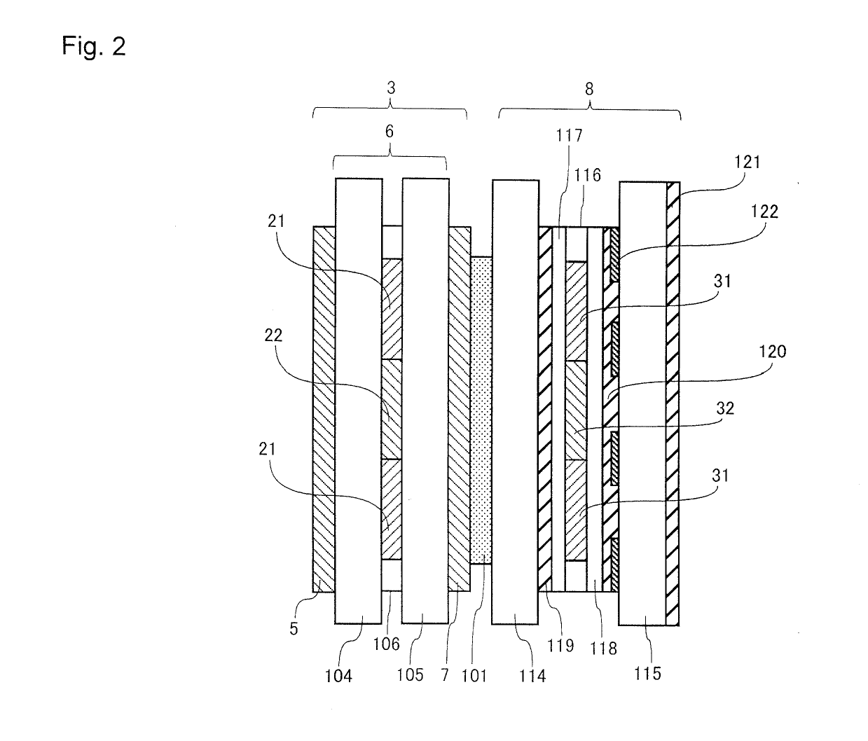

FIG. 2 is a schematic sectional view of the liquid crystal display 3 portion and switching retarder 8 portion of the stereoscopic image display apparatus 1 according to the present embodiment. As illustrated in FIG. 2, the liquid crystal display 3 and the switching retarder 8 are layered in the stereoscopic image display apparatus 1, and fixed to each other by an adhesive 101 without a gap.

The liquid crystal display 3 has the liquid crystal panel 6 sandwiched by a pair of the polarizing plate 5 and polarizing plate 7.

This liquid crystal panel 6 is configured such that a liquid crystal 106 is sandwiched by a pair of substrates, substrate 104 and a substrate 105. Further, in an image display portion of the liquid crystal panel 6, the first image forming areas 21 and the second image forming areas 22 are provided as described above. Furthermore, a configuration is possible where the first image forming areas 21 and the second image forming areas 22 are alternately provided to correspond to all horizontal lines of the liquid crystal panel 6 for displaying images.

Next, a configuration of a switching retarder 8 as an optical unit will be described.

As illustrated in FIG. 2, the switching retarder 8 employs a configuration including a pair of opposing substrate 114 and substrate 115. In the opposing surfaces of the substrates 114 and 115, transparent electrodes 119 and 120 made of ITO (as one example) are disposed. Further, oriented films 117 and 118 for orienting liquid crystal are provided on the transparent electrodes 119 and 120. The liquid crystal 116 is sandwiched by a pair of substrates 114 and 115 having these transparent electrodes 119 and 120 and oriented films 117 and 118 to form the switching retarder 8. Consequently, with the switching retarder 8, by applying a voltage to the transparent electrodes 119 and 120 on the substrates 114 and 115, it is possible to cause a change of orientation of the liquid crystal 116.

In this case, with the switching retarder 8, patterning of the transparent electrodes 119 and 120 on the substrates 114 and 115 is performed, or different orientation processing is performed per area corresponding to the first image forming areas 21 and the second image forming areas 22. Therefore, it is possible to change the orientation state of the liquid crystal 116 per area corresponding to the first image forming areas 21 and the second image forming areas 22 of the liquid crystal panel 6. By this means, with the switching retarder 8, the first polarizing areas 31 and the second polarizing areas 32 are formed such that the orientation change of the liquid crystal can be induced individually according to the range of the first image forming areas 21 and the second image forming areas 22 of the liquid crystal panel 6, that is, their positions and sizes.

Further, in the switching retarder 8, a phase difference film 121 is disposed on the front surface side which is the viewer 50 side. Further, the phase difference film 121 of the switching retarder 8 forms a ¼ wave plate having the optical axis in a direction of the upper right at 45 degrees (the upper right at 45 degrees in the drawing) from the horizontal direction when the viewer 50 looks at the stereoscopic image display apparatus 1. Further, between the substrate 115 and the transparent electrode 120 provided on the substrate 115 and in the positions corresponding to the boundary areas between the first polarizing areas 31 and the second polarizing areas 32, black matrices 122 (described below) are provided as light blocking units.

According to the above configuration, in the state where the stereoscopic image display apparatus 1 is used, when one frame image is displayed, right eye image light transmitted through the above-mentioned first image forming areas 21 is incident on the first polarizing areas 31. Further, left eye image light transmitted through the above-mentioned second image forming areas 22 is incident on the second polarizing areas 32. Further, in the case where image forming areas of a right eye image and a left eye image are replaced following switching of a frame, left eye image light transmitted through the first image forming areas 21 is incident on the first polarizing areas 31. Further, right eye image light transmitted through the second image forming areas 22 is incident on the second polarizing areas 32.

Moreover, according to FIG. 2, the switching retarder 8 according to the present embodiment can change the orientation of the liquid crystal 116 as described above, and change phase difference states of the first polarizing areas 31 and the second polarizing areas 32. In this case, it is possible to independently change phase difference states of the first polarizing areas 31 and the second polarizing areas 32. Consequently, when image forming areas of a right eye image and a left eye image are replaced in the liquid crystal display 3 following switching of a frame, in synchronization with this replacement, the switching retarder 8 can switch respective phase difference states of the first polarizing areas 31 and the second polarizing areas 32.

That is, the image forming areas of a right eye image and a left eye image are replaced following switching of a frame. After switching of the frame, the second polarizing areas 32 can have the phase difference state which the first polarizing areas 31 had before switching of a frame. Similarly, after switching of the frame, the first polarizing areas 31 can have the phase difference state which the second polarizing areas 32 had before switching of the frame.

Furthermore, as mentioned above, in the stereoscopic image display apparatus 1 according to the present embodiment, first image forming areas 21 and the second image forming areas 22 can be configured so as to correspond to individual horizontal lines of the image display of the liquid crystal panel 6. In this case, in the switching retarder 8, patterning of the transparent electrodes 119 and 120 is performed, or orientation processing of the oriented films 117 and 118 is performed in the range of first image forming areas 21 and second image forming areas 22 corresponding to individual horizontal lines 23 of liquid crystal panel 6, that is, the range corresponds to position and size. As a result, first polarizing areas 31 and second polarizing areas 32, corresponding to first image forming areas 21 and second image forming areas 22, corresponding to individual horizontal lines 23 of liquid crystal panel 6, are formed.

Further, a right eye image and a left eye image are displayed respectively on the first image forming areas 21 associated with odd horizontal lines of one frame image to be displayed and the second image forming areas 22 associated with even horizontal lines. For example, the horizontal lines for displaying the right eye image and the left eye image are replaced alternately, every time a frame is switched. The replacement of phase difference states such as the above-mentioned, is performed in synchronization with the replacement in first polarizing area 31 and second polarizing area 32 of switching retarder 8, further, it is possible to, for example, display a frame image interlacing the right eye image and the left eye image respectively.

The improvement to the stereoscopic image display apparatus 1 by the switching retarder 8 according to this embodiment, as a way of reducing crosstalk will now be described. There is a case where the viewer 50 views stereoscopic images on the stereoscopic image display apparatus 1 at a view angle from the center in the vertical direction of the liquid crystal display 3 forming the screen of the stereoscopic image display apparatus 1. Originally, when one frame image is displayed, only right eye image light transmitted through the first image forming areas 21 of the liquid crystal panel 6 needs to be incident on the first polarizing areas 31 of the switching retarder 8 and left eye image light transmitted through the second image forming areas 22 needs to be incident on the second polarizing areas 32. By contrast with this, when a large view angle is taken, part of right eye image light transmitted through the first image forming areas 21 of the liquid crystal panel 6 is incident on the second polarizing areas 32 on which only left eye image light needs to be incident and reaches the left eye of the viewer 50 as is, together with the left eye image light.

This type of crosstalk occurs because the first polarizing areas 31 and the second polarizing areas 32 having different phase difference characteristics are provided to be adjacent to each other in the switching retarder 8.

That is, as described above, in the liquid crystal panel 6 of the stereoscopic image display apparatus 1 according to the present embodiment, a first image forming area 21 and second image forming area 22 are provided vertically from the top, these first and second image forming areas are substantially the same size. Further, the first polarizing areas 31 and the second polarizing areas 32 of the switching retarder 8 are provided to be adjacent to each other, and therefore crosstalk is likely to occur when the viewer 50 views images on the screen at a certain view angle or more in the up and down directions of the screen of the stereoscopic image display apparatus 1.

This type of crosstalk occurs at boundary areas between the first polarizing areas 31 and the second polarizing areas 32 of the switching retarder 8 which are adjacent to each other.

Hence, it is effective to provide the black matrices 122 between the first polarizing areas 31 and the second polarizing areas 32 in the surface of the switching retarder 8 opposing to the liquid crystal display 3. The black matrices 122 preferably have a belt shape and are disposed at positions corresponding to the boundary areas between the first polarizing areas 31 and the second polarizing areas 32.

By providing these black matrices 122, it is possible to absorb and block image light which goes beyond the boundary areas and is incident on the adjacent first polarizing areas 31 among right eye image light or left eye image light which needs to be incident on the second polarizing areas 32 adjacent to the first polarizing areas 31 of the switching retarder 8.

Similarly, by providing the black matrices 122, it is possible to absorb and block image light which is right eye or left eye image light which needs to be incident on the first polarizing areas 31 adjacent to the second polarizing areas 32 of the switching retarder 8, and which is incident on the adjacent second polarizing areas 32 across the boundary with the first polarizing areas 31. Thus, by providing the black matrices 122 as blocking portions in the switching retarder 8, it is possible to make crosstalk less likely to occur in right eye image light and left eye image light emitted from the stereoscopic image display apparatus 1.

Further, with the switching retarder 8, patterning of the transparent electrodes 119 and 120 on the substrates 114 and 115 is performed, or orientation processing of the oriented films 117 and 118 is performed per above polarizing area. Consequently, it is possible to change the orientation state of the liquid crystal 116 such that the states are different between the first polarizing areas 31 and the second polarizing areas 32 to correspond to the first image forming areas 21 and second image forming areas 22 of the liquid crystal panel 6. Hence, the switching retarder 8 has a concern that disclination of the liquid crystal occurs due to different changes of the orientations of different liquid crystals at the boundaries between the first polarizing areas 31 and the second polarizing areas 32.

Consequently, by providing the black matrices 122, it is possible to cover disclination of the liquid crystal which occurs at the boundaries between the adjacent first polarizing areas 31 and second polarizing areas 32. Further, it is possible to prevent the influence of disclination of the liquid crystal on right eye or left eye image light.

These black matrices 122 are generally formed by photo-etching and relief-forming a deposited chrome thin film according to a photolithography method. Further, this black matrices 122 is preferably made of a material in which a filler component is dispersed in a binder resin.

For the filler component, metal particles and their oxides, or pigment and dye are used. The color hue of the filler component is preferably black with respect to the above right eye image light and left eye image light. For the binder resin in which the above pigment and dye are dispersed or dissolved, a common resin such as acrylic resin, urethane resin, polyester, novolac resin, polyimide, epoxy resin, vinyl chloride-vinyl acetate copolymer, cellulose nitrate, or combinations thereof can be used.

Further, when the structure of the switching retarder 8 is focused upon from the viewpoint of improvement of crosstalk, making substrates which form the switching retarder 8 more suitable is very effective.

As illustrated in FIG. 2, it is possible to select and use transparent and high strength glass substrates for the substrates 114 and 115 forming the switching retarder 8. However, there are concerns that the thicknesses of the substrates 114 and 115 increase and the occurrence of the above crosstalk increases.

Therefore, it is desirable to select and use thinner substrates while maintaining the high strength and transparency for the substrates 114 and 115.

For these substrates 114 and 115, it is possible to select a polycarbonate (PC) film, triacetylcellulose (TAC) film, cycloolefin polymer (COP) film, or polyethersulfone (PES) film. More particularly, it is desirable to use a transparent organic/inorganic compound film which combines glass and epoxy resin, that is, a glass cloth reinforced transparent film.

The glass cloth reinforced transparent film is manufactured as follows. First, a long glass cloth is impregnated with resin and dried to a half-cured state. Further, the glass cloth is cut to an appropriate size in this half-cured state, laminated and pressed at a temperature at which the resin is cured to form a desired glass cloth reinforced transparent film. This glass cloth reinforced transparent film adopts a structure in which the glass cloth is laminated in the epoxy resin matrix and has a low coefficient of thermal expansion particularly in the planar direction of the glass cloth.

The glass cloth reinforced transparent film has high heat resistance and high dimensional stability against the temperature and moisture. Further, the high transparency is realized by making the optical properties of epoxy resin and glass similar. Furthermore, it is possible to improve the gas barrier property by covering the film with silicon dioxide, and form ITO on the surface.

When this glass cloth reinforced transparent film is used for the substrates 114 and 115, it is possible to make the substrates 114 and 115 thinner, lighter and harder to crack.

As described above, the construction of the switching retarder 8 is effective in the improvement of reducing crosstalk. Furthermore, the switching retarder 8 and polarized glasses 10 will be explained in the following.

As illustrated in FIG. 1, for example, right eye image light is incident on the first polarizing areas 31 as linear polarized light having the polarizing axis in the direction vertical to the horizontal direction. Further, selection of the orientation state of the liquid crystal 116 and the function of the phase difference film 121 enable this incident right eye image light to be output as counterclockwise circular polarized light. Further, similarly in this case, with the second polarizing area 32, selection of the orientation state of the liquid crystal 116 and the function of the phase difference film 121 enable incident left eye image light to be output as clockwise circular polarized light.

Next, performing switching in the switching retarder 8 and changing the orientation state of the liquid crystal 116 allows the realization of different orientation states of the liquid crystal 116 in the first polarizing areas 31 and the second polarizing areas 32. In this case, the change of the orientation state and the function of the phase difference film 121 enable left eye image light incident on the first polarizing areas 31 to be output as clockwise circular polarized light. Further, with the second polarizing area 32, selection of the orientation state of the liquid crystal 116 and the function of the phase difference film 121 enable incident right eye image light to be output as counterclockwise circular polarized light.

Accordingly, right eye image light transmitted through the first polarizing areas 31 and left eye image light transmitted through the second polarizing areas 32 become circular polarized lights with the rotation directions opposite to each other as indicated by the arrow shown in FIG. 1. In addition, the arrow in the switching retarder 8 in FIG. 1 schematically indicates the rotation direction of polarized light transmitted through this switching retarder.

Further, the above stereoscopic image display apparatus 1 may have a diffusing plate which diffuses right eye image light and left eye image light transmitted through the first polarizing areas 31 and the second polarizing areas 32 of the switching retarder 8 in at least one of the horizontal direction and vertical direction toward the viewer beyond the switching retarder 8. For this diffusing plate, a lenticular lens sheet in which a plurality of D-shaped convex lenses (cylindrical lenses) which extend in the horizontal direction or vertical direction are arranged, or a lens array sheet in which a plurality of convex lenses are arranged in a plane shape is used.

When the viewer 50 views stereoscopic images using the stereoscopic image display apparatus 1, the viewer 50 views right eye image light and left eye image light projected from the stereoscopic image display apparatus 1 wearing the polarized glasses 10. With these polarized glasses 10, a right eye glass 41 is arranged in the position corresponding to the right eye of the viewer 50 and a left eye glass 42 is arranged in the position corresponding to the left eye.

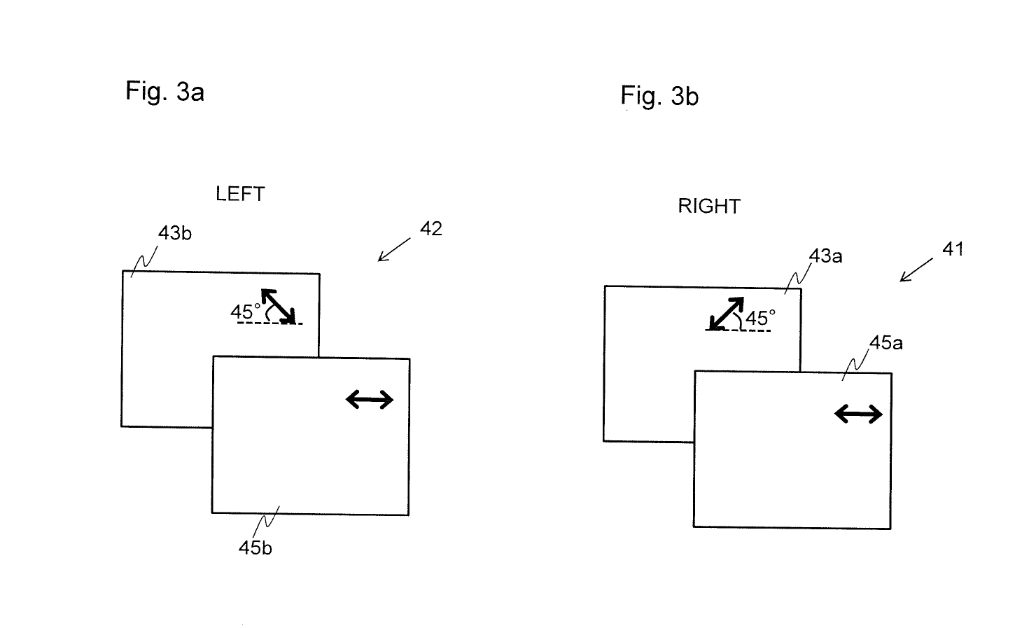

FIG. 3 is a schematic exploded perspective view describing configurations of the right eye glass 41 and the left eye glass 42. Specifically, FIG. 3(a) illustrates the configuration of the left eye glass 42, and FIG. 3(b) illustrates the configuration of the right eye glass 41.

As illustrated in FIGS. 3(a) and 3(b), the right eye glass 41 and the left eye glass 42 forming the polarized glasses 10 have ¼ wave plates 43a and 43b and polarizing plates 45a and 45b, respectively, in this order, and these are fixed to the frame.

In this case, with the polarized glasses 10 according to the present embodiment, when the viewer 50 faces the liquid crystal display 3 wearing the polarized glasses 10, the optical axis of the ¼ wave plate 43a of the right eye glass 41 is in a direction of the upper right at 45 degrees (the upper right at 45 degrees in the drawings) from the horizontal direction. Further, the transmission axis of the polarizing plate 45a is in a direction parallel to the horizontal direction. Hence, right eye image light and left eye image light which are respectively circular polarized lights transmitted through the first polarizing areas 31 and the second polarizing areas 32 of the switching retarder 8 of the stereoscopic image display apparatus 1 are incident on the ¼ wave plates 43a and 43b provided in the right eye glass 41 and the left eye glass 42 and output as linear polarized lights according to the functions of the ¼ wave plates 43a and 43b.

Although the main configuration of the stereoscopic image display apparatus 1 according to the present embodiment has been described, more specific configuration examples of the switching retarder 8 which is the main part of the stereoscopic image display apparatus 1 according to the present embodiment will be described next.

As illustrated in FIG. 2, the switching retarder 8 of the stereoscopic image display apparatus 1 according to the present embodiment can induce a change of the orientation of the liquid crystal 116 by applying the voltage to the transparent electrodes 119 and 120 on the substrates 114 and 115. The switching retarder 8 can be formed using various liquid crystal modes used for the liquid crystal display. For example, the switching retarder 8 can be formed with a TN (Twisted Nematic) liquid crystal element, homogeneous liquid crystal element or ferroelectric liquid crystal element.

Hereinafter, configuration examples of the switching retarder 8 according to the present embodiment will be described using FIG. 2. In addition, common members of each configuration example will be assigned common reference numerals for ease of description.

First, an example of a manufacturing method and a configuration where a TN liquid crystal element is used will be described as a first configuration example of the switching retarder 8 according to the present embodiment.

To manufacture the switching retarder 8 which is an example using the TN liquid crystal element, the substrates 114 and 115 formed of the glass cloth reinforced transparent films are first prepared. Further, as described above, the black matrices 122 patterned in a belt shape are formed on the substrate 115 on the front side. Next, transparent conductive layers (for example, ITO films) having the thickness of 100 nm to 140 nm are formed on the respective substrates 114 and 115 using a sputtering method, and then the transparent conductive layers are patterned using a photolithography method to form the transparent electrodes 119 and 120.

Subsequently, the orientated films 117 and 118 having the thickness of 50 nm are formed on the transparent electrodes 119 and 120 using a spin coating method such that the liquid crystal is horizontally oriented at a predetermined pre-tilting angle, and rubbing processing is applied to these oriented films 117 and 118. In this case, the rubbing processing is applied to the oriented films 117 and 118 such that the rubbing directions are orthogonal to each other when the substrates 114 and 115 are arranged to oppose to each other.

Next, a pair of the substrates 114 and 115 is adhered such that a cell gap which is an inter-substrate distance therebetween is 5.2 μm. More specifically, after a plastic spacer (not illustrated) is applied to one of the substrates, a pair of the substrates 114 and 115 is arranged to oppose to each other and cured using a thermosetting adhesive printed in the surrounding of the display area to fix both the substrates.

Subsequently, the liquid crystal 116 is formed by filling a liquid crystal material in the gap between the substrates 114 and 115 using a vacuum injection method. In this case, the liquid crystal material which contains 0.15 wt % of an optically-active material CB15 in a nematic liquid crystal material with a refractive index anisotropy (An) of 0.0924 is used.

By so doing, the liquid crystal 116 is placed in the oriented state twisted at 90 degrees in the initial state which is the state where no voltage is applied. Hence, by inducing the change of the orientation of the liquid crystal 116, the switching retarder 8 which is an example using the TN liquid crystal element functions to switch between two states, i.e., a state where the liquid crystal 116 optically rotates at 90 degrees and a state where the liquid crystal 116 does not have such optical rotation. In addition, when the liquid crystal 116 optically rotates at 90 degrees, the switching retarder 8 which is an example using the TN liquid crystal element can emit image light, which is incident as linear polarized light having the polarizing axis in a direction vertical to the horizontal direction, as linear polarized light parallel to the horizontal direction.

Next, the switching retarder 8 which is an example using the TN liquid crystal element is positioned to correspond to the pixels of the above liquid crystal display 3 for displaying images. Further, the switching retarder 8 is adhered by means of the adhesive 101.

An example of a manufacturing method and a configuration using a homogeneous liquid crystal element will be described as a second configuration example of the switching retarder 8 according to the present embodiment.

To manufacture the switching retarder 8 which is an example using the homogeneous liquid crystal element, the substrates 114 and 115 formed of the glass cloth reinforced transparent films are first prepared. Further, as described above, the black matrices 122 patterned in a belt shape are formed on the substrate 115 on the front side. Next, transparent conductive layers (for example, ITO films) having the thickness of 100 nm to 140 nm are formed on the respective substrates 114 and 115 using the sputtering method, and then the transparent conductive layers are patterned using the photolithography method to form the transparent electrodes 119 and 120.

Subsequently, the orientated films 117 and 118 having the thickness of 50 nm are formed on the transparent electrodes 119 and 120 using a spin coating method such that the liquid crystal is horizontally oriented at a predetermined pre-tilting angle, and rubbing processing is applied to these oriented films 117 and 118. In this case, the rubbing processing is applied to the oriented films 117 and 118 such that the rubbing directions are parallel to each other when the substrates 114 and 115 are arranged to oppose to each other and the orientation direction is an upper left direction at 45 degrees (the upper left at 45 degrees in the drawings) from the horizontal direction when the viewer 50 looks at the stereoscopic image display apparatus 1.

Next, a pair of the substrates 114 and 115 is adhered such that a cell gap which is an inter-substrate distance therebetween is 1.03 μm. More specifically, after a plastic spacer (not illustrated) is applied to one of the substrates, a pair of the substrates 114 and 115 is arranged to oppose to each other and cured using a thermosetting adhesive printed in the surrounding of the display area to fix both the substrates.

Subsequently, the liquid crystal 116 is formed by filling a liquid crystal material (BL035 and Δn=0.267 made by Merck KGaA) in the gap between the substrates 114 and 115 using a vacuum injection method. By so doing, the liquid crystal 116 portion of the switching retarder 8 using the homogeneous liquid crystal element has a phase difference value corresponding to the ½ wavelength based on 550 nm. Hence, by inducing the change of the orientation of the liquid crystal 116 per polarizing area, the switching retarder 8 using the homogeneous liquid crystal element functions to switch between two states, i.e., a state where there is no phase difference and a state of the ½ wave plate where the phase difference is the ½ wavelength. Next, the switching retarder 8 using the homogeneous liquid crystal element is positioned to correspond to the pixels of the above liquid crystal display 3 for displaying pixels. Further, the switching retarder 8 is adhered by means of the adhesive 101.

Further, an example of a manufacturing method and a configuration using a ferroelectric liquid crystal element will be described as a third configuration example of the switching retarder 8 according to the present embodiment.

To manufacture the switching retarder 8 which is an example using the ferroelectric liquid crystal element, the substrates 114 and 115 formed of the glass cloth reinforced transparent films are first prepared. Further, as described above, the black matrices 122 patterned in a belt shape are formed on the substrate 115 on the front side. Next, transparent conductive layers (for example, ITO films) having the thickness of 100 nm to 140 nm are formed on the entire upper surfaces of the respective substrates 114 and 115 in a solid state using the sputtering method to form the transparent electrodes 119 and 120.

Then, the photo-alignment oriented films 117 and 118 having the thicknesses of 30 nm are formed on the transparent electrodes 119 and 120 using the spin coating method such that liquid crystal is horizontally oriented, and photo-aligning technique is applied to these oriented films 117 and 118 to form horizontally oriented films. In this case, to correspond to the first polarizing areas 31 and the second polarizing areas 32 of the switching retarder 8 using the ferroelectric liquid crystal element, photo-aligning processing is applied according to a condition set per polarizing area such that the orientation directions of the liquid crystal 116 realized when the voltage is applied to the liquid crystal 116 become different.

Next, a pair of the substrates 114 and 115 is adhered such that a cell gap which is an inter-substrate distance therebetween is 3 μm. More specifically, after a plastic spacer (not illustrated) is applied to one of the substrates, a pair of the substrates 114 and 115 is arranged to oppose to each other and cured using a thermosetting adhesive printed in the surrounding of the display area to fix both the substrates.

Then, the liquid crystal 116 is formed by filling a ferroelectric liquid crystal material (Δn=0.25 and cone angle 45 degrees) in the gap between the substrates 114 and 115 using the vacuum injection method. In addition, assuming that the liquid crystal modulation factor is about 70%, Δn of the liquid crystal and the cell gap are selected such that the phase difference of the liquid crystal 116 has the ½ wavelength at this modulation factor. By so doing, when the voltage is applied to the transparent electrodes 119 and 120 and the voltage is applied uniformly to the plane of the liquid crystal 116, the optical axis of the liquid crystal 116 of the first polarizing areas 31 is in the horizontal direction, or in the direction of the upper left at 45 degrees (the upper left at 45 degrees in the drawings) from the horizontal direction when the viewer 50 looks at the stereoscopic image display apparatus 1. Further, the second polarizing areas 32 have a different state from the first polarizing areas, and the optical axis is in the direction of the upper left at 45 degrees (the upper left at 45 degrees in the drawings) from the horizontal direction, or in the horizontal direction.

Further, when the voltage of a different polarity is applied to the transparent electrodes 119 and 120 and the voltage is applied uniformly to the plane of the liquid crystal 116, the optical axis of the liquid crystal 116 of the first polarizing areas 31 is in the direction of the upper left at 45 degrees (the upper left at 45 degrees in the drawings) from the horizontal direction, or in the horizontal direction when the viewer 50 looks at the stereoscopic image display apparatus 1. Further, the second polarizing areas 32 has a different state from the first polarizing areas, and the optical axis of the liquid crystal 116 is in the horizontal direction, or in the direction of the upper left at 45 degrees (the upper left at 45 degrees in the drawings) from the horizontal direction.

That is, when the voltages of different polarities are applied to the first polarizing areas 31 and the second polarizing areas 32 of the switching retarder 8 using the ferroelectric liquid crystal element, the first polarizing areas 31 and the second polarizing areas 32 are respectively switched between the horizontal direction and the direction of the upper left at 45 degrees. Further, in this case, the first polarizing areas 31 and the second polarizing areas 32 are configured such that the optical axes of the liquid crystal 116 are shifted at 45 degrees.

Next, the switching retarder 8 using the ferroelectric liquid crystal element is positioned to correspond to the pixels of the above liquid crystal display 3 for displaying pixels. Then, the switching retarder 8 is adhered by means of the adhesive 101.

In addition, although the entire surface of the structure of the transparent electrodes 119 and 120 is solid in the above example, it is also possible to pattern and use the transparent electrodes 119 and 120 similar to the switching retarder 8 using the above TN liquid crystal element. In this case, it is also possible to pattern the transparent electrodes 119 and 120 in a stripe shape to correspond to the first polarizing areas 31 and the second polarizing areas 32 of the switching retarder 8 using the ferroelectric liquid crystal element. By so doing, it is possible to induce a change of an orientation of the liquid crystal 116 at arbitrary portions of the first polarizing areas 31 and the second polarizing areas 32. That is, it is possible not only to induce a change of an orientation of the liquid crystal 116 entirely all at once, but also to sequentially induce a change of an orientation of the liquid crystal 116 at arbitrary portions in an arbitrary order.

Although specific configuration examples of the switching retarder 8 have been described above, if the transparent electrodes 119 and 120 of the switching retarder 8 are patterned, the liquid crystal element desirably adopts a different structure, from a structure in the case where a liquid crystal element is used as a display element, as in conventional cases.

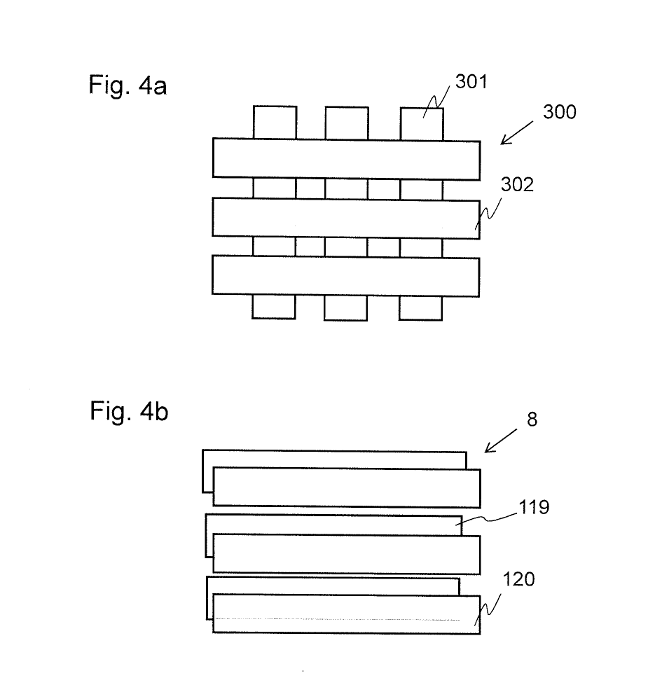

FIG. 4(a) is a view schematically illustrating an electrode structure of a conventional passive driving liquid crystal display element, and FIG. 4(b) is a view schematically illustrating an electrode structure of the switching retarder according to the present embodiment.

As illustrated in FIG. 4(a), with a conventional passive driving liquid crystal element 300, upper electrodes 302 and lower electrodes 301 are patterned respectively in a stripe pattern, and disposed in a matrix pattern to be orthogonal to each other.

By contrast with this, as illustrated in FIG. 4(b), with the switching retarder 8 according to the present embodiment, the transparent electrodes 120 on the upper side and the transparent electrodes 119 on the lower side are patterned in a stripe pattern to cause passive driving. However, the transparent electrodes 120 and 119 are preferably arranged parallel without being disposed in a matrix pattern.

Further, it is also possible to faun the switching retarder 8 according to the present embodiment using an active driving liquid crystal element.

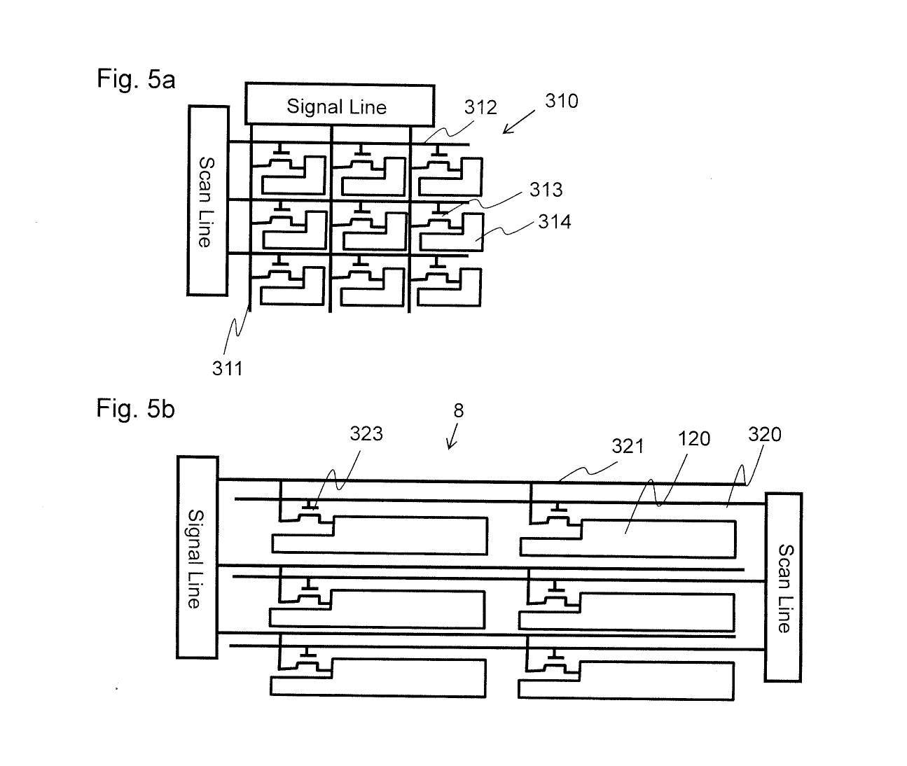

FIG. 5(a) is a view schematically illustrating a configuration of a conventional active driving liquid crystal display element 310, and FIG. 5(b) is a view schematically illustrating a configuration of main parts of the switching retarder 8 according to the present embodiment using the active driving liquid crystal element.

As illustrated in FIG. 5(a), with the conventional active driving liquid crystal display element 310, scan lines 312 and signal lines 311 are disposed in a matrix pattern to be orthogonal to each other, and at their intersections, active elements 313 are provided and pixel electrodes 314 are arranged.

By contrast with this, as illustrated in FIG. 5(b), when the switching retarder 8 according to the present embodiment is formed using an active driving liquid crystal element, scan lines 320 and signal lines 321 are disposed in parallel. Further, the pixel electrode which is the transparent electrode 120 on the upper side preferably adopts a horizontally long structure having the maximum horizontal width which enables the active element 323 to drive the liquid crystal 116.

The configuration of the stereoscopic image display apparatus 1 according to the present embodiment has been described, and a method will be next described which makes the viewer 50 recognize stereoscopic images based on right eye image light and left eye image light using the stereoscopic image display apparatus 1 according to the present embodiment.

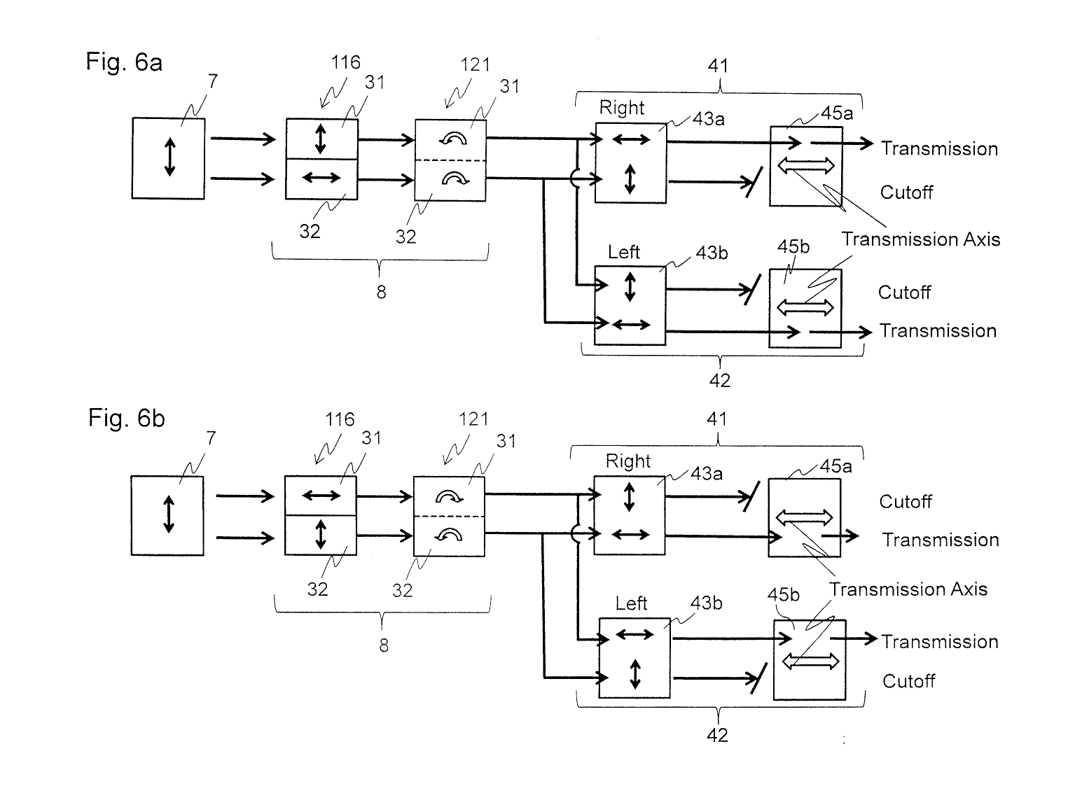

FIGS. 6(a) and 6(b) are views describing a method of making the viewer 50 recognize stereoscopic images using the stereoscopic image display apparatus 1 according to the present embodiment. Further, FIG. 6(a) is a view describing a method of making the viewer 50 recognize one frame image, and FIG. 6(b) is a view describing a method of making the viewer 50 recognize a frame image after image display areas are replaced following switching of a frame.

When the viewer 50 views a stereoscopic image using the stereoscopic image display apparatus 1, a right eye image and a left eye image are respectively formed as described above in the corresponding first image forming areas 21 and second image forming areas 22 of the liquid crystal panel 6 upon display of one frame image.

Further, as indicated by the arrow in FIG. 6(a), right eye image light transmitted through the first image forming areas 21 and left eye image light transmitted through the second image forming areas 22 transmit through the polarizing plate 7, and become linear polarized lights having polarizing axes in a direction vertical to the horizontal direction.

Then, the right eye image light and the left eye image light are incident on the switching retarder 8. In this case, in the first polarizing areas 31 of the liquid crystal 116, the switching retarder 8 allows linear polarized light incident from the polarizing plate 7 to be incident on the phase difference film 121. Further, in the second polarizing areas 32, linear polarized light is converted to have a polarizing axis in a direction parallel to the horizontal direction and be incident on the phase difference film 121

Hence, as indicated by the arrow in FIG. 6(a), in the first polarizing areas 31 of the switching retarder 8 on which right eye image light is incident, this incident right eye image light is emitted as counterclockwise circular polarized light. Still further, as indicated by the arrow in FIG. 6(a), the second polarizing areas 32 emit incident left eye image light as clockwise circular polarized light.

Next, the right eye image light and the left eye image light obtained in this way are incident on the polarized glasses 10 which the viewer 50 wears. As illustrated in FIG. 3, the polarized glasses 10 have the right eye glass 41 and the left eye glass 42.

In this case, with the polarized glasses 10, light transmits through the ¼ wave plate 43a provided in the right eye glass 41, is converted into linear polarized light parallel to the horizontal direction and reaches the right eye of the viewer 50.

By contrast with this, when right eye image light which is counterclockwise circular polarized light is incident on the left eye glass 42, as indicated by the arrow in FIG. 6(a), the right eye image light transmits through the ¼ wave plate 43b provided in the left eye glass 42 and is converted into linear polarized light vertical to the horizontal direction. Further, although the right eye image light is incident on the polarizing plate 45b, the right eye image light cannot transmit through and is blocked by the polarizing plate 45b and does not reach the left eye of the viewer 50.

Further, the left eye image light which is clockwise circular polarized light transmits through the ¼ wave plate 43b provided in the left eye glass 42 and is converted into linear polarized light parallel to the horizontal direction and reaches the left eye of the viewer 50.

By contrast with this, when left eye image light which is clockwise circular polarized light is incident on the right eye glass 41, the left eye image light transmits through the ¼ wave plate 43a provided in the right eye glass 41 and is converted into linear polarized light vertical to the horizontal direction. Further, although the left eye image light is incident on the polarizing plate 45a, the left eye image light cannot transmit through and is blocked by the polarizing plate 45a, and does not reach the right eye of the viewer 50.

Thus, when the viewer 50 views the stereoscopic image display apparatus 1 wearing the polarized glasses 10 as described above in the range where right eye image light and left eye image light transmitted through the first polarizing areas 31 and the second polarizing areas 32 of the switching retarder 8 are emitted, the right eye can view only right eye image light and the left eye can view only left eye image light. Consequently, the viewer 50 can recognize these right eye image light and left eye image light as stereoscopic images.

Next, a case will be described where, as shown in FIG. 6(b), when the viewer 50 views a stereoscopic image using the stereoscopic image display apparatus 1, image areas are replaced following switching of a frame as described above, and a left eye image and a right eye image are formed respectively on the first image forming areas 21 and the second image forming areas 22 in the liquid crystal panel 6.

In this case, following replacement of image forming areas following switching of a frame, phase difference states of the first polarizing areas 31 and the second polarizing areas 32 are switched in the switching retarder 8. More specifically, the phase difference state of the first polarizing areas 31 switches to the same phase difference state of the second polarizing areas 32 before switching of a frame. Further, the phase difference state of the second polarizing areas 32 switches to the same phase difference state as the phase difference state of the first polarizing areas 31 before switching of a frame.

Hence, similar to the above case, left eye image light transmitted through the first image forming areas 21 in the liquid crystal panel 6 and right eye image light transmitted through the second image forming areas 22 transmit through a polarizing plate 7 as indicated by the arrow in FIG. 6(b), become linear polarized lights respectively having polarizing axes vertical to the horizontal direction.

Further, although left eye image light and right eye image light are incident on the switching retarder 8, the left eye image light is incident on the first polarizing areas 31 of the switching retarder 8. Furthermore, as indicated by the arrow in FIG. 6(b), this incident left eye image light is emitted as clockwise circular polarized light. Still further, in the second polarizing areas 32, incident right eye image light is emitted as counterclockwise circular polarized light.

Next, the left eye image light and the right eye image light obtained in this way are incident respectively on the polarized glasses 10 which the viewer 50 wears.

As a result, with the polarized glasses 10, when left eye image light which is clockwise circular polarized light is incident on the right eye glass 41, as indicated by the arrow in FIG. 6(b), the left eye image light transmits through the ¼ wave plate 43a provided in the right eye glass 41 and is converted into linear polarized light vertical to the horizontal direction, is incident on, but cannot transmit through and is blocked by the polarizing plate 45a and therefore does not reach the right eye of the viewer 50.

By contrast with this, left eye image light which is clockwise circular polarized light is incident on the left eye glass 42 and transmits through the ¼ wave plate 43b provided in the left eye glass 42, is converted into linear polarized light parallel to the horizontal direction as indicated by the arrow in FIG. 6(b), transmits through the polarizing plate 45b as is, and reaches the left eye of the viewer 50.

Further, as indicated by the arrow in FIG. 6(b), right eye image light which is counterclockwise circular polarized light transmits through the ¼ wave plate 43a provided in the right eye glass 41, is converted into linear polarized light parallel to the horizontal direction, transmits through the polarizing plate 45a as is, and reaches the right eye of the viewer 50.

By contrast with this, when right eye image light which is counterclockwise circular polarized light is incident on the left eye glass 42, as indicated by the arrow in FIG. 6(b), the right eye image light transmits through the ¼ wave plate 43b provided in the left eye glass 42, is converted into linear polarized light vertical to the horizontal direction, is incident on, but cannot transmit through and is blocked by the polarizing plate 45b and therefore does not reach the left eye of the viewer 50.

Thus, when the viewer 50 views the stereoscopic image display apparatus 1 wearing the polarized glasses 10 in the range where left eye image light and right eye image light transmitted through the first polarizing areas 31 and the second polarizing areas 32 of the switching retarder 8 are emitted, even if image areas to form right eye and left eye images are replaced following switching of a frame, the right eye can view only right eye image light and the left eye can view only left eye image light.

Consequently, the viewer 50 can recognize the right eye image light and left eye image light as stereoscopic images at all times.

Accordingly, with a conventional stereoscopic image display apparatus, image areas to form right eye and left eye images are fixed, the vertical resolution is reduced and therefore all resolution is reduced, whereas the stereoscopic image display apparatus 1 according to the present embodiment enables display at the full resolution which fully utilize the capabilities of the liquid crystal display 3 without decreasing the resolution at all.

Further, with a conventional stereoscopic image display apparatus, there are cases where only one of left eye and right eye images is displayed at all times, and there is a time lag to recognize the three dimension, whereas the stereoscopic image display apparatus 1 according to the present embodiment displays left eye and right eye images at all times, and can alleviate fatigue of the viewer. Further, the stereoscopic image display apparatus also provides an effect of preventing a sense of difference in the stereoscopic view from being produced by misalignment of left and right images which occurs in the case of fast moving stereoscopic images.

Although the method has been described above which makes the viewer 50 recognize stereoscopic images using the stereoscopic image display apparatus 1 according to the present embodiment, the more detailed function of the switching retarder 8 in this case will be described based on the above specific example. In addition, each specific example will be described by assigning the same reference numerals to common members for ease of description. The same applies below.

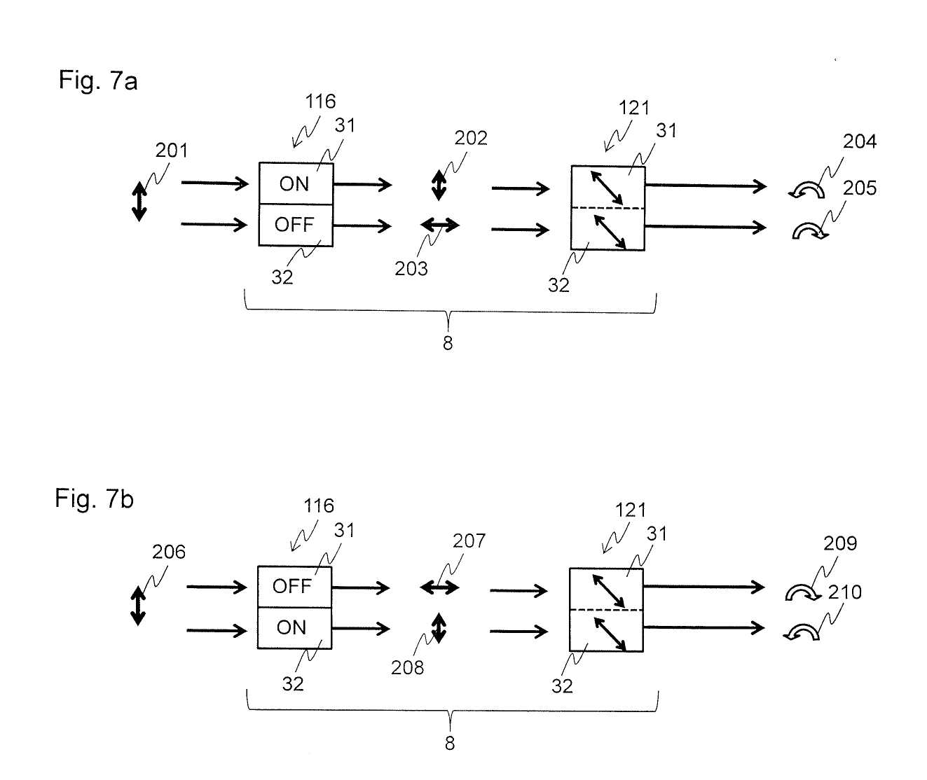

FIGS. 7(a) and 7(b) are views describing the configuration and function of the switching retarder 8 using a TN liquid crystal element according to the first example of the switching retarder 8 of the present embodiment.

In the switching retarder 8 using the TN liquid crystal element according to the first example of the switching retarder 8, the transparent electrodes 119 and 120 are patterned to correspond to the first image forming areas 21 and the second image forming areas 22 of the liquid crystal panel 6, and the first polarizing areas 31 and the second polarizing areas 32. Consequently, it is possible to select the on state and select the off state of the liquid crystal upon application of the voltage, independently in the first polarizing areas 31 and the second polarizing areas 32, and independently change the orientation of the liquid crystal.

Consequently, as illustrated in FIG. 7(a), when linear polarized light 201 from the polarizing plate 7 of the liquid crystal display 3 is incident on the switching retarder 8 using the TN liquid crystal element, it is possible to place the liquid crystal 116 of the first polarizing areas 31 of the switching retarder 8 in the on state, and induce a change of the orientation of the liquid crystal. Further, it is possible to place the liquid crystal 116 of the second polarizing areas 32 in the off state without applying the voltage to the liquid crystal 116, and maintain the initial orientation state (90 degree twisted orientation) of the liquid crystal.

As a result, the linear polarized light 201 transmits through the first polarizing areas 31 as is, without optical rotation, and is incident on the phase difference film 121 as linear polarized light 202.

Further, the linear polarized light 201 is converted into linear polarized light 203 having the rotated optical axis parallel to the horizontal direction in the second polarizing areas 32 having optical rotation, and is incident on the phase difference film 121.

Further, the function of the phase difference film 121 which is a ¼ wave plate converts the linear polarized light 202 and the linear polarized light 203 respectively into counterclockwise circular polarized light 204 and clockwise circular polarized light 205.

Next, as illustrated in FIG. 7(b), when linear polarized light 206 from the polarizing plate 7 of the liquid crystal display 3 is incident on the switching retarder 8 using the TN liquid crystal element, the liquid crystal 116 of the first polarizing areas 31 of the switching retarder 8 is placed in the off state without having the voltage applied, and maintains the initial orientation state of the liquid crystal. Further, in the second polarizing areas 32, the liquid crystal 116 is placed in the on state by having the voltage applied, and induces a change of the orientation of the liquid crystal.

As a result, the linear polarized light 206 is converted into linear polarized light 207 having the rotated optical axis parallel to the horizontal direction in the first polarizing areas 31 having optical rotation, and is incident on the phase difference film 121.

Further, the linear polarized light 206 transmits through the second polarizing area 32 as is, without optical rotation, and is incident on the phase difference film 121 as linear polarized light 208.

Further, the function of the phase difference film 121 which is a ¼ wave plate converts the linear polarized light 207 and the linear polarized light 208 respectively into clockwise circular polarized light 209 and counterclockwise circular polarized light 210.

Next, a configuration and function of the switching retarder 8 using the homogeneous liquid crystal element according to the second example of the switching retarder 8 of the present embodiment will be described.

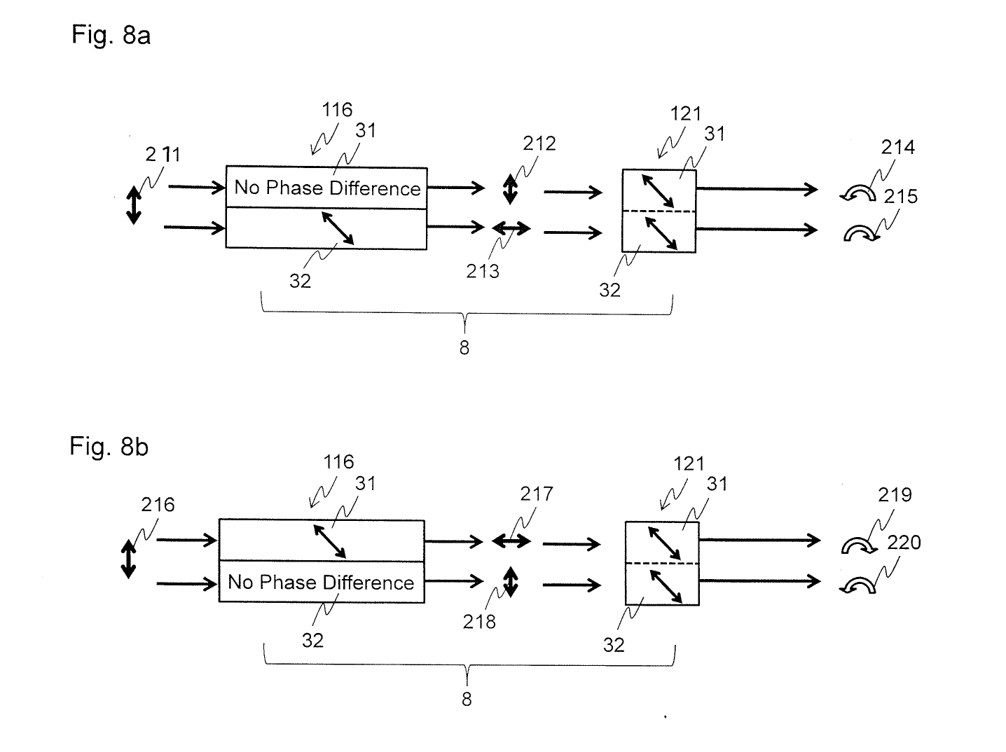

FIGS. 8(a) and 8(b) are views describing the configuration and function of the switching retarder 8 using the homogeneous liquid crystal element according to the second example of the switching retarder 8 of the present embodiment.

In the switching retarder 8 using the homogeneous liquid crystal element, the transparent electrodes 119 and 120 are patterned to correspond to the first image forming areas 21 and the second image forming areas 22 respectively in the liquid crystal panel 6, and the first polarizing areas 31 and the second polarizing areas 32. Consequently, it is possible to select the on state and select the off state of the liquid crystal upon application of the voltage, independently in the first polarizing areas 31 and the second polarizing areas 32, and independently change the orientation of the liquid crystal.

Consequently, as illustrated in FIG. 8(a), when linear polarized light 211 from the polarizing plate 7 of the liquid crystal display 3 is incident on the switching retarder 8 using the homogeneous liquid crystal element, it is possible to place the liquid crystal 116 of the first polarizing areas 31 of the switching retarder 8 in the on state, and induce a change of the orientation of the liquid crystal. Further, it is possible to place the liquid crystal 116 of the second polarizing areas 32 in the off state without having the voltage applied, and maintain the initial orientation state of the liquid crystal.

In addition, in this case, the switching retarder 8 using the homogeneous liquid crystal element functions to switch and select between two states, i.e., a state where there is no phase difference and a state where the phase difference is a ½ wavelength. That is, the switching retarder 8 using the homogeneous liquid crystal element can select an area in which there is no phase difference per polarizing area of the first polarizing areas 31 and the second polarizing areas 32, and an area which functions as a ½ wave plate. Further, the initial orientation state of the liquid crystal 116 is a parallel orientation. In addition, the orientation direction is a direction of an arrow shown in the second polarizing area 32 illustrated in FIG. 8(a), and is a direction of an arrow shown in the first polarizing area 31 illustrated in FIG. 8(b). That is, the orientation direction is in the direction of the upper left at 45 degrees (the upper left at 45 degrees in the drawings) from the horizontal direction. Hence, the second polarizing area 32 in FIG. 8(a) and the first polarizing area 31 in FIG. 8(b) having the liquid crystal 116 in the off state function as a ½ wave plate having the optical axis in the direction of the upper left at 45 degrees.

As a result, the linear polarized light 211 transmits as is through the first polarizing areas 31 in which there is no phase difference, and is incident on the phase difference film 121 as linear polarized light 212.

Further, the linear polarized light 211 is converted into linear polarized light 213 having the rotated optical axis parallel to the horizontal direction in the second polarizing areas 32 in which the phase difference is the ½ wavelength, and is incident on the phase difference film 121.

Further, the function of the phase difference film 121 which is a ¼ wave plate converts the linear polarized light 212 and the linear polarized light 213 respectively into counterclockwise circular polarized light 214 and clockwise circular polarized light 215.

Next, as illustrated in FIG. 8(b), when linear polarized light 216 from the polarizing plate 7 of the liquid crystal display 3 is incident on the switching retarder 8 using the homogeneous liquid crystal element, the liquid crystal 116 of the first polarizing areas 31 of the switching retarder 8 is placed in the off state without having the voltage applied, and maintains the initial orientation state of the liquid crystal. Further, in the second polarizing areas 32, the liquid crystal 116 is placed in the on state by having the voltage applied to induce a change of the orientation of the liquid crystal.

As a result, the linear polarized light 216 is converted into linear polarized light 217 having the rotated optical axis parallel to the horizontal direction in the first polarizing areas 31 in which there is a phase difference, and is incident on the phase difference film 121. Further, the linear polarized light 216 transmits through the second polarizing areas 32 in which there is no phase difference as is, and is incident on the phase difference film 121 as linear polarized light 218. Furthermore, the function of the phase difference film 121 which is a ¼ wave plate converts the linear polarized light 217 and the linear polarized light 218 respectively into clockwise circular polarized light 219 and counterclockwise circular polarized light 220.

Next, a configuration and a function of the switching retarder 8 using the ferroelectric liquid crystal element which is a third example of the switching retarder 8 according to the present embodiment will be described.

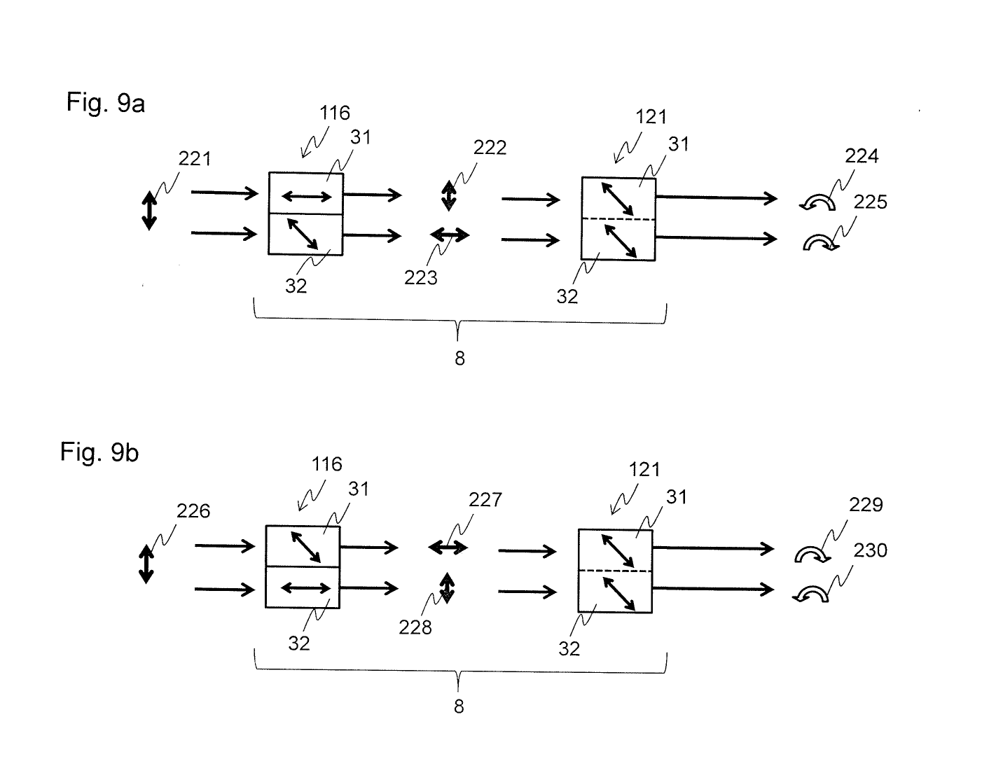

FIGS. 9(a) and 9(b) are views describing the configuration and function of the switching retarder 8 using the ferroelectric liquid crystal element which is the third example of the switching retarder 8 according to the present embodiment. The switching retarder 8 using the ferroelectric liquid crystal element uses two stable liquid crystal orientation states which can be selected by applying the voltage of a different polarity to the switching retarder 8.

With the switching retarder 8 using the ferroelectric liquid crystal element, the first polarizing areas 31 and the second polarizing areas 32 are provided to correspond to the first image forming areas 21 and the second image forming areas 22 of the liquid crystal panel 6, respectively. Further, in the first polarizing areas 31 and the second polarizing areas 32, orientation processing of the oriented films 117 and 118 is performed such that the liquid crystal 116 is placed in an orientation state in a different direction upon application of a voltage.

Hence, as illustrated in FIG. 9(a), when linear polarized light 221 is incident on the switching retarder 8 from the polarizing plate 7 of the liquid crystal display 3, it is possible to simultaneously apply the voltage to the liquid crystal 116 of the first polarizing areas 31 and the second polarizing areas 32 of the switching retarder 8 using the ferroelectric liquid crystal element, and to induce the change of the orientation of the liquid crystal. Further, it is possible to place the liquid crystal in an oriented state in a different direction. Further, upon application of the voltage, the first polarizing areas 31 and the second polarizing areas 32 function as ½ wave plates having the optical axes in different directions. In this case, the orientation direction of the liquid crystal 116 upon voltage application in the first polarizing areas 31 is the horizontal direction when the viewer 50 looks at the stereoscopic image display apparatus 1. By contrast with this, the orientation direction in the second polarizing areas 32 is an upper left direction at 45 degrees (the upper left at 45 degrees in the drawings) when the viewer 50 looks at the stereoscopic image display apparatus 1.

Hence, when the voltage is applied to the liquid crystal 116, the first polarizing areas 31 function as the ½ wave plate having the optical axis in the horizontal direction. By contrast with this, the second polarizing areas 32 function as the ½ wave plate having the optical axis in an upper left direction at 45 degrees (the upper left at 45 degrees in the drawings) from the horizontal direction.

As a result, the linear polarized light 221 passes through the first polarizing areas 31 as is, and is incident on the phase difference film 121 as linear polarized light 222.

Further, in the second polarizing areas 32 in which the optical axis is in the upper left direction at 45 degrees from the horizontal direction and the phase difference is half the wavelength, the linear polarized light 221 is converted into linear polarized light 223 having the rotated optical axis parallel to the horizontal direction, and is incident on the phase difference film 121.

Furthermore, the function of the phase difference film 121 which is a ¼ wave plate converts the linear polarized light 222 and the linear polarized light 223 into counterclockwise circular polarized light 224 and clockwise circular polarized light 225, respectively.

Next, as illustrated in FIG. 9(b), when linear polarized light 226 from the polarizing plate 7 of the liquid crystal display 3 is incident on the switching retarder 8 using the ferroelectric liquid crystal element, it is possible to simultaneously apply the voltages of different polarities to the liquid crystal 116 of the first polarizing areas 31 and the second polarizing areas 32 of the switching retarder 8 and induce the change of the orientation of the liquid crystal, and to provide the orientation state in a direction different from above.

As a result, in the first polarizing areas 31, the orientation direction of the liquid crystal 116 upon voltage application is the upper left direction at 45 degrees (the upper left at 45 degrees in the drawings) when the viewer 50 looks at the stereoscopic image display apparatus 1. By contrast with this, in the second polarizing areas 32, the orientation direction is the horizontal direction when the viewer 50 looks at the stereoscopic image display apparatus 1.

Consequently, when the voltage is applied to the liquid crystal 116, the first polarizing areas 31 function as the ½ wave plate having the optical axis in the upper left direction at 45 degrees (the upper left at 45 degrees in the drawings) from the horizontal direction. By contrast with this, the second polarizing areas 32 function as the ½ wave plate having the optical axis in the horizontal direction.

As a result, in the first polarizing areas 31 in which the optical axis is in the upper left direction at 45 degrees from the horizontal direction and the phase difference is half the wavelength, the linear polarized light 226 is converted into linear polarized light 227 having the rotated optical axis parallel to the horizontal direction, and is incident on the phase difference film 121. By contrast with this, the linear polarized light 226 passes through the second polarizing areas 32 as is, and is incident on the phase difference film 121 as linear polarized light 228.

Further, the function of the phase difference film 121 which is the ¼ wave plate converts the linear polarized light 227 and the linear polarized light 228 into clockwise circular polarized light 229 and counterclockwise circular polarized light 230, respectively.

In addition, the above switching retarder 8 using the ferroelectric liquid crystal element employs, for example, a configuration in which the transparent electrodes 119 and 120 to be used have an entirely solid plate shape without being patterned, and in which the voltage is applied to the entire liquid crystal. However, it is also possible to pattern the transparent electrodes 119 and 120 similar to the switching retarder 8 using the above TN liquid crystal element. Further, instead of applying the voltage uniformly to the entire liquid crystal and temporarily inducing a change of the orientation of the liquid crystal 116, it is also possible to sequentially apply the voltage to the first polarizing areas 31 and the second polarizing areas 32 respectively in the liquid crystal 116, and sequentially select the orientation state in the liquid crystal 116.

Next, the operation of the stereoscopic image display apparatus 1 according to the present embodiment will be described.

As described above, to display stereoscopic images, the stereoscopic image display apparatus 1 according to the present embodiment simultaneously displays a right eye image and a left eye image on one frame image. Further, the stereoscopic image display apparatus 1 adopts a scheme of sorting images to the left and right eyes of the viewer using the switching retarder of the above optical unit and displaying stereoscopic images. In this case, it is effective to first divide all horizontal scan lines continuously aligned in the vertical direction of the display screen, into the first image forming areas 21 and the second image forming areas 22 each formed with an individual or plurality of horizontal lines 23 in order to display all pieces of image information.

Further, using a method of simultaneously displaying one of either a right eye image or a left eye image on the first image forming areas and the other image on the second image forming areas, replacing image forming areas for displaying the left eye image and the right eye image following switching of a frame at a predetermined cycle and, at the same time as the image forming areas are replaced, switching the state of polarization phase differences of the states of first polarizing areas and second polarizing areas of switching retarder is effective to display and watch all pieces of image information.

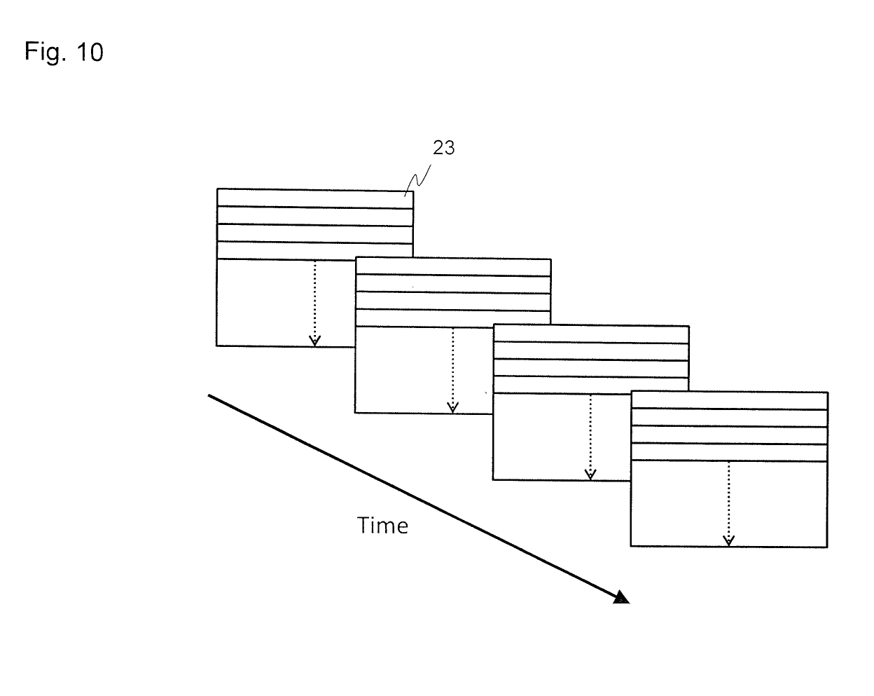

However, when the above liquid crystal display 3 is used in the stereoscopic image display apparatus 1, as illustrated in FIG. 10, information of a frame image is updated by sequentially overwriting and updating the screen from the horizontal line 23 at the top of the screen to the horizontal line 23 at the bottom. Therefore, the viewer simultaneously views a previous image and the next new image at all times. As a result, the stereoscopic image display apparatus 1 has a problem that crosstalk, in which the viewer views with the left eye an image which needs to be viewed with the right eye frequently occurs, and the viewer 50 has difficulty in recognizing stereoscopic images. FIG. 10 is a view describing a display method of a common liquid crystal display.

In regard to this problem, with the first operation method example, the stereoscopic image display apparatus 1 according to the present embodiment can introduce a flashing operation of the backlight 2 to reduce the crosstalk caused when information of the frame image is updated.

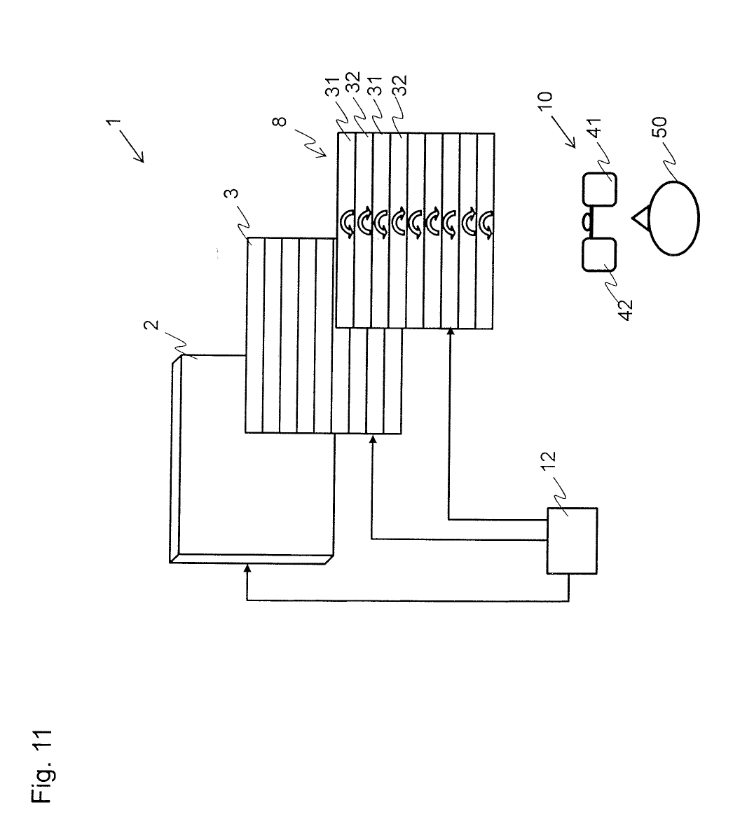

FIG. 11 explains the first operational method of the stereoscopic image display apparatus 1 according to the present embodiment.

As described above, the stereoscopic image display apparatus 1 according to the present embodiment has the backlight 2, the liquid crystal display 3 and the retarder 8 of optical unit in this order, and has the controlling apparatus 12. In addition, these components are accommodated in the housing (not shown). Further, as described above, the stereoscopic image display apparatus 1 has the polarized glasses 10 which the viewer uses to watch stereoscopic images.

The controlling apparatus 12 commands the liquid crystal display 3 to simultaneously output a right eye image and a left eye image on one frame image. When receiving this command the liquid crystal display 3 displays, for example, the right eye image and the left eye image respectively on the first image forming areas 21 and the second image forming areas 22 provided in association with a plurality of horizontal lines 23 continuously aligned in the vertical direction of the liquid crystal panel 6, which is the constituent component of the liquid crystal display 3. Simultaneously, the controlling apparatus 12 controls the switching retarder 8 to select and control the phase difference states in the first polarizing areas 31 and the second polarizing areas 32 associated with the first image forming areas 21 and the second image forming areas 22.

Further, every time a frame is switched, the liquid crystal panel 6 and the switching retarder 8 are controlled to alternately replace image forming areas which display the right eye image and the left eye image, and display a frame image in which the right eye image and the left eye image are alternately arranged. However, in order to prevent crosstalk, the controlling apparatus 12 can perform control such that the liquid crystal display 3 simultaneously displays the right eye image and the left eye image on one frame image and then does not replace the image forming areas in the next frame. In this case, the controlling apparatus 12 can control the liquid crystal display 3 to overwrite the images as is, to display the overwritten images in at least the next one frame period, and controls the switching retarder 8 to function according to the liquid crystal display 3.

The flicker of backlight is also controlled by the controller 12. That is, the backlight 2 is turned on in a period during which one frame image is displayed, and the backlight 2 is turned off in frames before and after that period, in which image forming areas displaying the right eye image and the left eye image are replaced or controlled to decrease the brightness appropriately. By so doing, it is possible to prevent residual images of the right eye image and the left eye image and the above crosstalk following switching of image areas from being sensed by the viewer 50.

According to the above operation method, even when areas which form right eye and left eye images are replaced at a predetermined cycle following switching of a frame, the viewer 50 can reliably view only right eye image light with the right eye and view only left eye image light with the left eye. Consequently, the viewer 50 can recognize the right eye image light and left eye image light as stereoscopic images at all times without sensing the above crosstalk resulting from replacement of image areas.

In addition, in the case where a right eye image and a left eye image are simultaneously displayed on one frame image, and then the images are overwritten without replacing image areas in the next frame, as described above, the number of times to switch images decreases and smoothness of display images in the liquid crystal display 3 is lost at the usual frame frequency of 60 Hz. Further, the backlight 2 is flashed at a cycle of 30 Hz per frame, and therefore there is a concern that the viewer senses this flashing and then can detect flicker resulting from the flashing.

Hence, it is preferable to increase the frame frequency in the liquid crystal display 3 to at least 120 Hz. By so doing, even when a right eye image and a left eye image are simultaneously displayed on one frame image and then overwritten as is, without replacing image areas in the next frame, it is possible to form stereoscopic images matching the frame frequency of 60 Hz, the number of times to switch images increases and there is no concern that the viewer 50 senses flicker. Further, flicker resulting from flashing of the above backlight 2 is not sensed by the viewer 50. Consequently, the stereoscopic image display apparatus 1 according to the present embodiment provides natural display images.

In addition, with the stereoscopic image display apparatus 1 according to the present embodiment, it is possible to set the frame frequency to 240 Hz in the liquid crystal display 3 controlled by the controlling apparatus 12. In this case, the controlling apparatus 12 can control the liquid crystal display 3 according to a pattern of simultaneously displaying a right eye image and a left eye image on one frame image, overwriting the images as is, without replacing image areas in the next frame, further replacing image areas in the subsequent frame and overwriting the images as is, in the following frame. That is, according to a pattern of repeating replacing display areas of a right eye image and a left eye image in the liquid crystal display 3 and overwriting the images per frame in this order, the controlling apparatus 12 can control image formation.

When images are formed on the liquid crystal display 3 at such a cycle, a stereoscopic image matching the frame frequency of 120 Hz can be formed, the number of times to switch images increases and there is no concern that the viewer 50 senses flicker. Further, the backlight 2 is flashed at the cycle of 120 Hz. Consequently, there is no concern that the viewer 50 senses flicker.

Further, when the frame frequency is 240 Hz in the liquid crystal display 3, the controlling apparatus 12 controls the liquid crystal display 3 to simultaneously display a right eye image and a left eye image on one frame image by switching a frame, and then overwrite images as is, without replacing image areas in subsequent three frames, so that it is also possible to display the overwritten images on the liquid crystal display 3 in the next three frame periods and form stereoscopic images matching the frame frequency of 60 Hz.

In this case, the backlight 2 can be turned off for a 1/240 second which is the first one frame period, and the backlight 2 can be turned on for 3/240 seconds which are three frame periods in which the overwritten images are displayed. In this case, although, compared to the above pattern of repeating replacing display areas of a right eye image and a left eye image in the liquid crystal display 3 per frame and overwriting the images as is, the number of times of replacement of image areas decreases, it is possible to reduce the period in which the backlight 2 is turned off in proportion to the decrease. As a result, it is possible to further increase the brightness of stereoscopic images in the stereoscopic image display apparatus 1.

Further, in this case, the backlight 2 is flashed at the cycle of 60 Hz. Consequently, there is no concern that the viewer senses flicker resulting from flashing of the backlight 2. As described above, by increasing the frame frequency of the liquid crystal display 3 to 120 Hz or 240 Hz, the viewer can enjoy natural and high-quality stereoscopic images.

Further, with the second operation method example, for the above problem, the stereoscopic image display apparatus 1 according to the present embodiment can reduce crosstalk resulting from an information update of a frame image while maintaining a high brightness without allowing the viewer to notice the flashing operation of the backlight 2.

That is, in the liquid crystal display 3, when a frame image is updated, the screen is sequentially updated from the upper horizontal line to the lower horizontal line on the screen of the liquid crystal display 3. Further, in synchronization with this update, the phase difference states of the first polarizing areas 31 and the second polarizing areas 32 are switched in the switching retarder 8. By so doing, it is possible to reduce crosstalk.

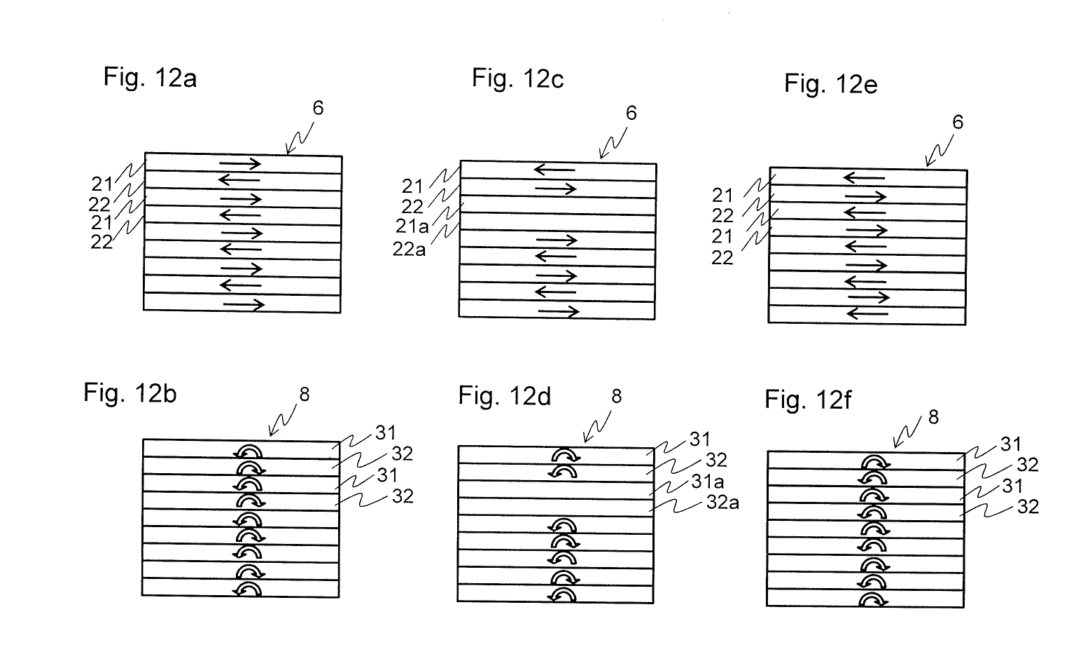

FIGS. 12(a) to 12(f) are views describing the second operation method of the stereoscopic image display apparatus 1 according to the present embodiment.

As described above, the controlling apparatus 12 of the stereoscopic image display apparatus 1 according to the present embodiment illustrated in FIG. 11 commands the liquid crystal display 3 to simultaneously output a right eye image and a left eye image on one frame image. Further, when receiving this command, the liquid crystal display 3 forms, for example, the following image on the liquid crystal panel 6 forming the liquid crystal display 3.

That is, as illustrated in FIG. 12(a), a right eye image and a left eye image are displayed on the first image forming areas 21 and the second image forming areas 22, respectively, which are alternately arranged, and continuously aligned in a vertical direction, corresponding to each horizontal line.

Further, at the same time, as illustrated in FIG. 12(b), the controlling apparatus 12 controls the switching retarder 8, and selects and controls the phase difference states such that the left eye and the right eye of the viewer 50 can appropriately sense the right eye image and the left eye image per first polarizing area 31 and second polarizing area 32 associated with the first image forming areas 21 and the second image forming areas 22.

In addition, in FIG. 12(a), arrows are shown in the first image forming areas 21 and the second image forming areas 22. The directions of these arrows serve to distinguish between a right eye image and a left eye image to be output. Hence, when a right eye image is output, a rightward arrow is shown and, when a left eye image is output, a leftward arrow is shown. The same applies to FIG. 12(c) and FIG. 12(e).

Further, as described below, in a first image forming area 21a and second image forming area 22a, in which arrows are not shown in FIG. 12(c), a right eye image and a left eye image are being switched. The same applies to FIG. 12(d) and, in a first polarizing area 31a and a second polarizing area 32a, the phase difference state is being switched.

Further, the liquid crystal panel 6 and the switching retarder 8 are controlled following switching of a frame to alternately replace or overwrite image forming areas which display a right eye image and a left eye image, and display a frame image in which the right eye image and the left eye image are alternately arranged.

In this case, in the liquid crystal panel 6, when image forming areas which display the right eye image and the left eye image are alternately replaced, as illustrated in FIG. 12(c), the screen is sequentially updated from the upper horizontal line of the screen to the lower horizontal line. In FIG. 12(c), the first image forming area 21a and second image forming area 22a are areas in which a right eye image and a left eye image are being switched.

In this case, the switching retarder 8 does not wait for the phase difference states to switch until the entire screen of the liquid crystal panel 6 is replaced according to control by the controlling apparatus 12. As illustrated in FIG. 12(d), even in the switching retarder 8, it is possible to switch the phase difference state of the first polarizing areas 31 and the phase difference state of the second polarizing areas 32 in association. That is, by controlling a signal synchronized with a scan signal for forming an image in the liquid crystal panel 6, as illustrated in FIG. 12(d), following an update of the screen of the liquid crystal panel 6, the phase difference states of the corresponding first polarizing areas 31 and second polarizing areas 32 of the switching retarder 8 are switched per area.

Further, when, as illustrated in FIG. 12(e), updating of images of the entire screen of the liquid crystal panel 6 is finished, as illustrated in FIG. 12(f), switching of the phase difference states of the entire first polarizing areas 31 and second polarizing areas 32 of the switching retarder 8 is simultaneously finished.

By adopting the above operation method, even when areas for forming a right eye image and a left eye image are replaced at a predetermined cycle following switching of a frame, the viewer 50 can view only right eye image light with the right eye, and view only left eye image light with the left eye. Consequently, the viewer 50 does not sense the above crosstalk resulting from replacement of the image forming areas, and can recognize these right eye image light and left eye image light as stereoscopic images at all times. Further, the stereoscopic image display apparatus 1 does not need to turn off the entire backlight 2 even in a frame in which image forming areas which display a right eye image and a left eye image on the liquid crystal panel 6 are replaced. As a result, the stereoscopic image display apparatus 1 can display bright stereoscopic images.

Further, it is also possible to use a scanning backlight technique in combination. That is, according to control by the controlling apparatus 12, it is possible to scan the backlight in conjunction with switching of the phase difference state of the first polarizing areas 31 and the phase difference state of the second polarizing area 32 in the switching retarder 8. In this case, according to control by the controlling apparatus 12, the backlight is turned off at a portion corresponding to a position of an area at which the phase difference states are switched in the switching retarder 8. As a result, it is possible to prevent crosstalk while keeping a decrease in the brightness at minimum.

The present invention is not limited to the above-mentioned embodiments and may be utilized without departing from the spirit and scope of the present invention.

### REFERENCE SIGNS LIST

1 Stereoscopic image display apparatus
2 Backlight
3 Liquid Crystal Display
5, 7, 45a, 45b Polarizing plate
6 Liquid Crystal Panel
8 Switching retarder
10 Polarized glasses
12 Controlling apparatus
21, 21a First image forming areas
22, 22a Second image forming areas
23 horizontal line
31, 31a First polarizing areas
32, 32a Second polarizing areas
41 Right eye glass
42 Left eye glass
43a, 43b ¼ wave plate
50 Viewer
101 Adhesive
104, 105, 114 and 115 Substrate
106 and 116 Liquid Crystal
117 and 118 Oriented Films
119 and 120 Transparent Electrodes
121 Phase Difference Film
122 Black matrices
201 and 202, 203, 206, 207, 208, 211, 212, 213, 216,
217, 218, 221, 222, 223, 226, 227 and 228 Linear Polarized Light
204, 205, 209, 210, 214, 215, 219, 220, 224, 225,
229 and 230 Circular Polarized Light
300 Passive Driving Liquid Crystal Element
301 Lower electrodes
302 Upper electrodes
310 Active driving liquid crystal display element
311 and 321 Signal lines
312 and 320 Scan lines
313 and 323 Active elements
314 Pixel electrodes

1. A stereoscopic image display apparatus comprising:
a liquid crystal display which comprises a liquid crystal panel including a plurality of horizontal rows of aligning pixels, the horizontal rows being arranged in vertical direction, and a pair of polarizing plates which sandwich the liquid crystal panel;
a backlight located on a back surface side of the liquid crystal display;
an optical unit located on a front surface side of the liquid crystal display;
polarizing eyeglasses worn by a viewer in viewing images on the liquid crystal display; and
a control apparatus which controls image display on the liquid crystal display, and phase difference states of the optical unit, wherein
the liquid crystal display comprises a first image forming area and a second image forming area, and is controlled by the control apparatus such that the first image forming area displays one of a right eye image and a left eye image and, simultaneously, the second image forming area displays the other image of the right eye image and the left eye image, and the liquid crystal display displays a frame image in which the right eye image and the left eye image are respectively interlaced,
the control apparatus controls the first image forming area and the second image forming area so that
(1) the right eye image and the left eye image are replaced every time a frame is switched, or
(2) the right eye image and the left eye image are replaced when the frame is switched or an image displayed in an immediately previous frame is overwritten,
the frames are switched at a rate of at least 120 Hz, and
the optical unit arranges a first polarizing area and a second polarizing area in ranges corresponding to the first image forming area and the second image forming area and the first polarizing area and the second polarizing area have respective different phase difference states, the different phase difference states being controlled by the control apparatus in synchronization with the timing at which the right eye image and the left eye image are replaced.

2. The stereoscopic image display apparatus according to claim 1, wherein
the optical unit the first polarizing area and the second polarizing area are controlled by the control apparatus to have the respective, different phase difference states, and
the phase difference states are replaced between the first polarizing area and the second polarizing area in synchronization with the timing at which the right eye image and the left eye image are replaced in the liquid crystal display.

3. The stereoscopic image display apparatus according to claim 1, wherein
the first image forming area and the second image forming area correspond to horizontal rows for displaying a stereoscopic image on the liquid crystal display, the first image forming area corresponds to odd horizontal rows and the second image forming area corresponds to even horizontal rows,
the odd horizontal rows display one of a right eye image and a left eye image, and the even horizontal rows display the other image of the right eye image and the left eye image,
the horizontal rows
(1) replace a right eye image and a left eye image every time the frame is switched, or
(2) replace the right eye image and left eye image when a frame is switched, or an image displayed in an immediately previous frame is overwritten, and
in the optical unit, a first polarizing area and a second polarizing area are arranged in ranges corresponding to the odd horizontal rows and the even horizontal rows and have respective, different phase difference states, the different phase difference states being controlled by the control apparatus to replace the first polarizing area and the second polarizing area in synchronization with the timing at which the right eye image and the left eye image are replaced.

4. The stereoscopic image display apparatus according to claim 1, wherein the control apparatus controls each an entire lighting state of the backlight according to the timing at which the right eye image and the left eye image are replaced, or
lighting state of the backlight is controlled following replacement of phase difference states between the first polarizing area and the second polarizing area, thereby scanning.

5. The stereoscopic image display apparatus according to claim 1, wherein the control apparatus controls each horizontal row of the liquid crystal display, thereby controlling replacement of the right eye image and the left eye image in the liquid crystal display, and controls a phase difference state of the first polarizing area or the second polarizing area of the optical unit corresponding to the controlled horizontal rows of the liquid crystal display.

6-12. (canceled)

13. The stereoscopic image display apparatus according to claim 1, wherein the optical unit includes a pair of substrates, a liquid crystal material sandwiched between the pair of substrates, and transparent electrodes disposed on opposing outer surfaces of the substrates and providing a phase difference on surfaces of the substrates.

14. The stereoscopic image display apparatus according to claim 13, including a light blocking unit located on a first substrate of the pair of substrates, in at least part of a boundary between the first polarizing area and the second polarizing area of the optical unit.

15. The stereoscopic image display apparatus according to claim 13, including a light blocking unit located on a first substrate of the pair of substrates, facing the liquid crystal material.

16. The stereoscopic image display apparatus according to claim 1, wherein the optical unit includes a liquid crystal material selected from the group consisting of a TN liquid crystal material, a homogeneous liquid crystal material, and a ferroelectric liquid crystal material.

17. The stereoscopic image display apparatus according to claim 13, wherein the pair of substrates of the optical unit include a film selected from the group consisting of polycarbonate, triacetylcellulose, cycloolefin polymer, polyethersulfone, and a reinforced transparent glass cloth.

18. The stereoscopic image display apparatus according to claim 1, wherein the frames of the liquid crystal display are switched at a rate of at least 240 Hz.

19. A stereoscopic image display apparatus comprising:
a liquid crystal display which comprises a liquid crystal panel including a plurality of horizontal rows of aligning pixels, the horizontal rows being arranged in vertical direction, and a pair of polarizing plates which sandwich the liquid crystal panel;
a backlight located on a back surface side of the liquid crystal display;
an optical unit located on a front surface side of the liquid crystal display;
polarizing eyeglasses worn by a viewer in viewing images on the liquid crystal display; and
a control apparatus which controls image display on the liquid crystal display, and phase difference states of the optical unit, wherein
the liquid crystal display comprises a first image forming area and a second image forming area, is controlled by the control apparatus such that the first image forming area displays one of a right eye image and a left eye image and, simultaneously, the second image forming area displays the other image of the right eye image and the left eye image and the liquid crystal display displays a frame image in which the right eye image and the left eye image are respectively interlaced,
the control apparatus controls the first image forming area and the second image forming area so that
(1) the right eye image and the left eye image are replaced every time a frame is switched, or
(2) the right eye image and the left eye image are replaced when a frame is switched or an image displayed in an immediately previous frame is overwritten,
the optical unit arranges a first polarizing area and a second polarizing area in ranges corresponding to the first image forming area and the second image forming area and the first polarizing area and the second polarizing area have respective different phase difference states, the different phase difference states being controlled by the control apparatus in synchronization with the timing at which the right eye image and the left eye image are replaced,
the optical unit includes a pair of substrates, a liquid crystal material sandwiched between the pair of substrates, and transparent electrodes disposed on opposing outer surfaces of the substrates and providing a phase difference on surfaces of the substrates, and
the pair of substrates of the optical unit include a film selected from the group consisting of polycarbonate, triacetylcellulose, cycloolefin polymer, polyethersulfone, and a reinforced transparent glass cloth.

20. The stereoscopic image display apparatus according to claim 19, including a light blocking unit located on a first substrate of the pair of substrates, in at least part of a boundary between the first polarizing area and the second polarizing area of the optical unit.

21. The stereoscopic image display apparatus according to claim 19, including a light blocking unit located on a first substrate of the pair of substrates, facing the liquid crystal material.

22. The stereoscopic image display apparatus according to claim 19, wherein the optical unit includes a liquid crystal material selected from the group consisting of a TN liquid crystal material, a homogeneous liquid crystal material, and a ferroelectric liquid crystal material.

23. The stereoscopic image display apparatus according to claim 19, wherein the frames in the liquid crystal display are switched at a rate of at least 120 Hz.

24. The stereoscopic image display apparatus according to claim 23, wherein the frames in the liquid crystal display are switched at a rate of at least 240 Hz.

25. A stereoscopic image display apparatus comprising:
a liquid crystal display which comprises a liquid crystal panel including a plurality of horizontal rows of aligning pixels, the horizontal rows being arranged in vertical direction, and a pair of polarizing plates which sandwich the liquid crystal panel;
a backlight located on a back surface side of the liquid crystal display;
an optical unit located on a front surface side of the liquid crystal display;
polarizing eyeglasses worn by a viewer in viewing images on the liquid crystal display; and
a control apparatus which controls image display on the liquid crystal display, and phase difference states of the optical unit, wherein
the liquid crystal display comprises a first image forming area and a second image forming area, and is controlled by the control apparatus such that the first image forming area displays one of a right eye image and a left eye image and, simultaneously, the second image forming area displays the other image of the right eye image and the left eye image, and the liquid crystal display displays a frame image in which the right eye image and the left eye image are respectively interlaced,
the control apparatus controls the first image forming area and the second image forming area so that
(1) the right eye image and the left eye image are replaced every time a frame is switched, or
(2) the right eye image and the left eye image are replaced when a frame is switched or an image displayed in an immediately previous frame is overwritten,
the optical unit arranges a first polarizing area and a second polarizing area in ranges corresponding to the first image forming area and the second image forming area, the first polarizing area and the second polarizing area have respective different phase difference states, the different phase difference states being controlled by the control apparatus in synchronization with the timing at which the right eye image and the left eye image are replaced, and
the optical unit includes a liquid crystal material selected from the group consisting of a homogeneous liquid crystal material and a ferroelectric liquid crystal material.

26. The stereoscopic image display apparatus according to claim 25, wherein the optical unit includes
a ferroelectric liquid crystal material,
a pair of substrates, a liquid crystal material sandwiched between the pair of substrates, and transparent electrodes disposed on and covering all of opposing outer surfaces of the substrates and providing a phase difference on surfaces of the substrates, and
an oriented film on the transparent electrodes, wherein
the oriented film is oriented according to a set condition of the first polarizing area and the second polarizing area such that orientation directions of the liquid crystal material realized, when a voltage is applied to the liquid crystal material, are different from each other, and
the different phase difference states of the first polarizing area and the second polarizing area are controlled by the control apparatus in synchronization with the timing at which the right eye image and the left eye image are replaced.

27. The stereoscopic image display apparatus according to claim 26, including a light blocking unit located on a first substrate of the pair of substrates, in at least part of a boundary between the first polarizing area and the second polarizing area of the optical unit.

28. The stereoscopic image display apparatus according to claim 26, including a light blocking unit located on a first substrate of the pair of substrates, facing the liquid crystal material.

29. The stereoscopic image display apparatus according to claim 25, wherein the pair of substrates of the optical unit include a film selected from the group consisting of polycarbonate, triacetylcellulose, cycloolefin polymer, polyethersulfone, and a reinforced transparent glass cloth.

30. The stereoscopic image display apparatus according to claim 25, wherein the frames in the liquid crystal display are switched at a rate of at least 120 Hz.

31. The stereoscopic image display apparatus according to claim 30, wherein the frames in the liquid crystal display are switched at a rate of at least 240 Hz.
